(19) United States
(12) Patent Application Publication
(10) Pub. No.: US 2002/0013720 A1
(43) Pub. Date: Jan. 31, 2002

(54) Business position display system and computer-readable medium

(75) Inventors: Michitaka Ozono, Chiba-City (JP); Tatsuyoshi Yamamoto, Soka-City (JP); Hideo Miyamaki, Nishitokyo-City (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Sumitomo Heavy Industries, Ltd.

(21) Appl. No.: 09/828,900

(22) Filed: Apr. 10, 2001

(30) Foreign Application Priority Data
Apr. 11, 2000 (JP) 2000-109740
May 22, 2000 (JP) 2000-150087

(51) Int. Cl. G06F 17/60

(52) U.S. Cl. 705/7

(57) ABSTRACT

A business position display system shows a business position of a business unit to be analyzed together with those for comparison. A management analysis database is a multi-dimensional database in which data sets including a combination of a plurality of evaluation values are classified in accordance with a variety of reference and stored. A management analysis server extracts a data set from the management analysis database in accordance with the extract conditions specified by the operator of a client computer. Then, the server calculates coordinates for each of the data sets extracted, in accordance with the combination of the evaluation values, to display an object at a point indicated by the coordinates on a portfolio map.

### BACKGROUND OF THE INVENTION

1. Field of the Invention

The present invention relates to a business position display system which displays analysis objects on a map representing a multi-dimensional space valuable for developing a business strategy in companies or the like. The present invention also relates to a computer-readable medium which stores multi-dimensional databases and programs for allowing a computer to function as the business position display system.

2. Description of the Related Art

Company management includes the business portfolio planning for determining the combination of businesses to grow the company. It also includes a series of strategic planning control processes for establishing targets of growth potential, competitive advantage, profitability, improvement of operation, and activation of personnel and organization, with respect to each business, then following the established targets on a daily basis to evaluate the performance, and therefore incorporating new themes into the subsequent targets. Management tools related to the company management include the Product Portfolio Management which is mainly used for determining how to assign investment in the business portfolio planning (which will be hereinafter referred to as “PPM”). The tools also include the Balanced Score Card (hereinafter referred to as “BSC”) for setting a business policy that is consistent with strategic targets of business and then relating the business policy to some quantitative management factors which can be controlled by operation, to follow improvement activities. In practice, these tools are used in various forms.

In PPM, there are lots of interested parties, and the analysis of business and the evaluation factors of activities and performance will be diverse and complicated, so that analysis objects such as businesses, products, organizations, personnel, or competitors are mapped onto a portfolio map such as two-dimensional coordinates or matrices in order to visualize the condition of the objects. Thus, the PPM has widely supported decision-making such as for management strategies, marketing strategies, or development strategies. The portfolio map that has been most widely used in practice is the portfolio matrix with its X-axis representing market share and its Y-axis representing the growth rate of market. The portfolio matrix is used for determining basic strategies by which a cash flow created by a matured business with a high market share but a low growth rate is aggressively directed to a business with a high market share and a high market growth rate; by which the cash flow is selectively directed to a business with a high market growth rate but a low share; and by which the cash flow is retreated from a business with a low share and low market growth rate. This approach can be effectively employed when two evaluation factors on respective axes are enough to analyze business, but various limitations are imposed thereon. In order to improve the level of analysis, a portfolio map with four axes is prepared, which includes one based on the SPACE (Strategic Position and Action Evaluation), described such as in the “STRATEGIC MANAGEMENT A METHODLOGICAL APPROACH FOURTH EDITION” published by ADDDISON-WESLEY PUBLISHING COMPANY.

According to the SPACE analysis, the evaluation factors to be applied to analysis objects are given evaluation scores from 0 to 5 and classified into the groups of ES (Environmental Stability), IS (Industrial Strength), CA (Company's Competitive Advantage), and FS (Company's Financial Strength), and an average value is calculated for each of the groups. Then, the averages determined for each group of factors are plotted on each of the IS, FS, CA, and EX axes, respectively, which are directed from a center to respective directions deviated one another by 90 degrees in that order in the counterclockwise direction. Then, each tow of points plotted on adjacent axes are connected by a diagonal line. Then, area of each triangle enclosed by a diagonal lines and corresponding pair of axes. Thus, results of analysis are determined for the analysis object based on the quadrant in which the triangle having the largest area is present.

For example, a business would be analyzed as follows. That is, if the triangle having the largest area lies in the quadrant between the CA axis and ES axis, it is analyzed that the business must adopt a strategy of changing the business model, rationalizing the organization, spinning off the business or retreating from the market. If the triangle having the largest area lies in the quadrant between the CA axis and FS axis, it is analyzed that the business should adopt a strategy of reducing cost, introducing a new product, or selecting products and customers. If the triangle having the largest area lies in the quadrant between the IS axis and EX axis, it is analyzed that the business should adopt a strategy of reducing cost, investing in productivity, merging with a cash-rich company, or enhancing the financial. If the triangle having the largest area lies in the quadrant between the IS axis and FS axis, it is analyzed that the business may adopt a strategy of expanding the business, M&A, tie-ups, or aggressive investment for improving competitive advantage.

On the other hand, in BSC, the following method is adopted so that it may be evaluated whether or not business activities and operations are performed in a balanced manner and improved to attain strategic targets and so that a gap between the current situation and the target may be grasped at an earlier stage to solve problems as soon as possible. Specifically, critical themes, which determine whether or not the business strategic targets are attained, are classified from four viewpoints such as stockholder's viewpoints, customer's viewpoints, viewpoints of business process, and viewpoints of organization and material. Additionally, respective critical themes are made associated with management index for quantitative evaluation and given a target value. Then, each critical theme is systematically followed up by comparing its actual results and the targets and displaying them every month, every quarter, every half year, or every year.

The aforementioned SPACE can provide analysis adapted better to economic theories with the four evaluation axes than with the two axes, however, it has a problem of its display method. Specifically, it is almost impossible for the SPACE to display a plural objects of analysis at the same time, since an object of analysis is displayed on the map by diagonal lines connecting plotted points to each other and by a vector indicating the direction of the presence of the triangle having the largest area. For this reason, the method cannot be adapted at all to display a plurality of items on one map, thus displaying only the current status of a particular object. Therefore, it is impossible to use the conventional SPACE management analysis approach for multi-aspect analysis such as analysis based on the comparison with other items, analysis based on the comparison with other companies, analysis of a change over time, and analysis of the level of achievement of target.

Furthermore, the conventional portfolio maps including the SPACE cannot make clear the bases for analyzing results, that is, reason why an analyzed object is positioned to a particular position, a person who has evaluated the item, and degree of improvement of evaluation factors or critical themes on management index to improve the position of the object. Thus, it is difficult to provide consensus in the organization or to extract true problems by use of the conventional portfolio map.

Furthermore, the PPM and BSC handles many common objects of analysis and use many common evaluation factors. Thus, if a system for displaying the both at the same time for analysis is available, the quality of management decision can be improved and analysis can be efficiently performed. However, since such a system is not currently available, data processing and reporting require much time. Furthermore, analyzing result based on the PPM may conflict with that based on the BSC.

Furthermore, the PPM is generally created to establish a medium-term plan every several years or at the time of making a yearly plan. However, since the environmental situations change drastically, the positioning provided once in several years or once a year could cause a problem to the validity thereof. Therefore, it is desirable to monitor the attractiveness of the market and environmental stability on a daily basis so as to immediately reflect a change in the market to a change in evaluation. Likewise, it is also necessary to immediately change the evaluation to cope with a constant change in market share and improvement in competitive advantage. Still moreover, the evaluation factors constituting the portfolio should not be fixed, but it is necessary that they can be modified so as to fit business characteristics and can be changed to the review of company targets.

Furthermore, the BSC is frequently displayed in the form of a comparison table between target values and actual results. However, like the PPM, visualizing the BSC as a portfolio map would facilitate checking how much the whole company has provided improvement. That is, comparative analysis of two visualized portfolio maps of the PPM and BSC would show potential problems that have not been handled by the conventional analysis approaches to allow the potential problems to be studied. These potential problems include such a situation where same business is positioned in the posture for aggressive investment according to the PPM but is evaluated not to be improved according to the BSC, a situation where same business is determined to be adopted a rationalizing strategy according to the PPM but seems to have obtained great improvement according the BSC.

Furthermore, the PPM analysis is performed on different layers such as the whole company, a business unit, and a product unit. Likewise, the setting of targets and the evaluation of actual results in the BSC should be applied to individual organization layers, that is, the whole company, divisions, functional sections constituting one division, and so on. Additionally, targets and actual results are respectively summed up for the whole organization. It is desirable that drilling-down and rolling-up can be performed freely in both PPM and BSC. However, if information system tools are not available, these are conducted in an extremely inefficient manner since collecting, processing, and editing information need to be carried out consistently with the purpose item by item. Furthermore, it is also necessary to prepare a sufficient amount of reference document to allow reference as desired in order to confirm the specification of an evaluation, however, this would be time consuming in practice.

Furthermore, such a system would be useful that uses the PPM to extract strategic targets and themes and then uses the BSC to follow them, thus working in accordance with basic practical procedures. However, such a system is no available.

### SUMMARY OF THE INVENTION

The present invention was developed on the basis of such problem consciousness. An object of the present invention is to provide a business position display system which can display the position of an analysis object under the business environment thereof on a map in such a manner as to allow the position of another object to be displayed thereon at once. Another object of the present invention provide a computer-readable medium which stores databases and programs for making a computer function as such a business position display system.

The business position display system according to the present invention has a storage device for storing evaluation values respectively set to a plurality of evaluation factors for every business unit to be analyzed, an extracting processor extracting evaluation values related to said business unit to be analyzed out of said storage device in accordance with a predetermined extracting condition, a coordinate calculating processor calculating coordinates in a multi-dimensional space in accordance with respective evaluation values extracted by the extracting processor, and a display processor showing an object at a position corresponding to the coordinates calculated by said coordinate calculating processor in said multi-dimensional space on a screen.

Such configuration makes it possible that the position of a business unit to be analyzed is indicated in the multi-dimensional space on a screen of a display device, with an object, such as a point or a bubble. Therefore, a plurality of objects can be displayed in a multi-dimensional space on a screen on the basis of a plurality of data sets extracted by the extracting processor according to various extracting conditions. Accordingly, the business position of the business unit to be analyzed can be compared with other business units for relative evaluation, and the distribution of a plurality of analyzed items can be investigated. Furthermore, even when only one object is displayed in a multi-dimensional space on a window, changes of the object over time can be displayed in an animated manner, for example.

If a multi-dimensional database in which a multi-dimensional space is logically defined with plurality of axes respectively representing reference is used in the storage device, the extracting processor can retrieve the database from various aspects to extract a desired evaluation value. More specifically, a multi-dimensional database can be retrieved in accordance with the logical product of retrieving conditions on respective axes, by setting the range of extracted evaluation values (that is, a retrieval condition) on respective axes in the multi-dimensional database. For example, the respective axes in the multi-dimensional database are those related to business unit (that is, an axis along which evaluation values for various business unit are present), time (that is, an axis along which evaluation values for the same business unit to be analyzed at various points of time are present), evaluators (that is, an axis along which evaluation values given by a plurality of evaluators to the same business unit to be analyzed are present), evaluation factors (that is, an axis along which evaluation values given to a plurality of evaluation factors for the same business unit to be analyzed item are present), plans and results (that is, an axis along which planned values and actual evaluation values for the same business unit to be analyzed are present), and soon. Therefore, evaluation values can be extracted in accordance with various references. In addition, a plurality of objects related to a business unit to be analyzed and other item for comparison can be displayed at a plurality of positions respectively calculated by the coordinate calculating processor in accordance with the extracted evaluation values. Thus, a multi-aspect analysis can be performed on the business unit to be analyzed.

### BRIEF DESCRIPTION OF THE DRAWINGS

The invention will be described below in detail with reference to the accompanying drawings, in which:

FIG. 1 is a block diagram showing a business position display system according to an embodiment of the present invention;

FIG. 2 is a table listing evaluation factors and criteria of evaluation scores related to the competitive advantage of business;

FIG. 3 is a table listing evaluation factors with their criteria of evaluation scores regarding to a financial structure;

FIG. 4 is a table listing evaluation factors with their criteria of evaluation scores regarding to the competitive principle of industry;

FIG. 5 is a table listing evaluation factors with their criteria of evaluation scores regarding to the attractiveness of market;

FIG. 6 is a tree diagram showing a structure of an organization axis;

FIG. 7 is a tree diagram showing a structure of a year axis;

FIG. 8 is a tree diagram showing a structure of a period axis;

FIG. 9 is a tree diagram showing a structure of a plan-result axis;

FIG. 10 is a tree diagram showing a structure of an evaluator axis;

FIG. 11 is a tree diagram showing a structure of a PPM evaluation factor axis;

FIG. 12 is a tree diagram showing a structure of a BSC evaluation factor axis;

FIG. 13 is a table showing a numerical example of evaluated values and average scores of evaluation factors;

FIG. 14 is a portfolio map displayed in accordance with FIG. 13;

FIG. 15 is flow chart showing the contents of the processing of a management analysis server;

FIG. 16 is flow chart showing the contents of the processing of a management analysis server;

FIG. 17 is flow chart showing a browse mode processing subroutine to be executed in S016 of FIG. 15;

FIG. 18 is flow chart showing a browse chart operation processing subroutine to be executed in S103 of FIG. 17;

FIG. 19 is flow chart showing a display operation processing subroutine to be executed in S104 of FIG. 17;

FIG. 20 is flow chart showing a bubble detail display processing subroutine to be executed in S105 of FIG. 17;

FIG. 21 is flow chart showing an edit mode processing subroutine to be executed in S108 of FIG. 15;

FIG. 22 is flow chart showing a PPM/BSC switching processing subroutine to be executed in S107 of FIG. 17;

FIG. 23 is a view showing a login screen;

FIG. 24 is a view showing a main screen;

FIG. 25 is a view showing a radar chart;

FIG. 26 is a view showing a detailed radar chart; and

FIG. 27 shows graphs for explaining the relationship between the position provided by PPM and that by BSC.

### DETAILED DESCRIPTION OF THE PREFERRED EMBODIMENTS

Now, the embodiments of the present invention are explained with reference to the drawings. Incidentally, in this specification, it is to be understood that analysis objects are business units (that is, a whole company, or business groups, divisions or products of the company which form a multi-layered configuration with each other).

Configuration of the business position display system

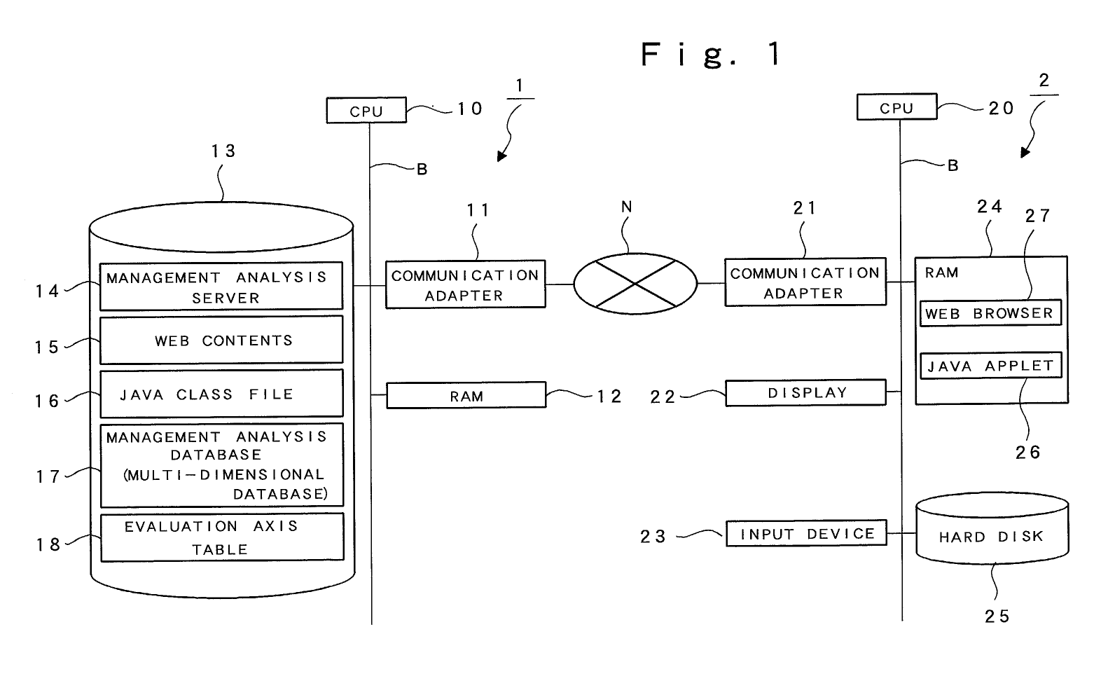

FIG. 1 is a block diagram showing the hardware configuration of the business position display system. As shown in FIG. 1, this business position display system has a host computer 1 and a plurality of client computers 2 (only one of which is shown in FIG. 1) which are connected so as to allow communications with each other as an intranet (or via the Internet) N.

The client computer 2 is such an ordinary personal computer as is used as a terminal device, composed of a CPU 20, a communication adapter 21, a display 22, an input device 23, a RAM 24, and a hard disk 25, which are all connected to one another via a bus B. Among them, the CPU 20 is a central processing unit for controlling the entire client computer 2. In addition, the communication adapter 21 is a LAN card which serves as an interface with the LAN circuit in which the intranet N is constructed or a modem serving as an interface with the public telephone circuit or the like. The display 22 is a display device for displaying images generated by the CPU 20. The input device 23 comprises a keyboard and a mouse.

The hard disk 25 stores various programs to be read and executed by the CPU 20. The programs stored in the hard disk 25 include an operating system having a function of communications with the host computer 1 via the communication adapter 21 in accordance with TCP/IP. The programs also include a Web browser 27 for transmitting various messages (such as URL) to the host computer 1 using the communication function of the operating system and for displaying Web contents (HTML documents or image files such as JPEG or GIF) that are transmitted by the host computer 1 in response to the messages. Incidentally, the Web browser 27 includes the Java plug-in function for executing a class file of a Java applet 26 transmitted by the host computer 1.

The RAM 24 is a main memory in which a work area is developed when the CPU 20 executes the aforementioned various programs. The class file of the Java applet 26 is downloaded to the work area in the RAM 24 and executed on the RAM 24.

On the other hand, the host computer 1 is a computer to be used as a server device, composed of a CPU 10, a communication adapter 11, a RAM 12, and a hard disk 13, which are all connected to one another via a bus B. Among them, the CPU 10 is a central processing unit for controlling the entire host computer 1. In addition, the RAM 12 is a main memory in which a work area is developed when the CPU 10 executes various processing. Moreover, the communication adapter 11 is a LAN card which serves as an interface with the LAN circuit in which the intranet N is constructed or a modem serving as an interface with the public telephone circuit or the like.

The hard disk 13 stores various programs and various data to be read and executed by the CPU 20. The programs stored in the hard disk 13 include an operating system (not shown) having a function of communications with each client computer 2 via the communication adapter 21 in accordance with TCP/IP. The programs also include a server program for sending information in response to a message that is transmitted by the client computer 2. When the message from the client computer 2 designates a URL of Web contents 15 stored in the hard disk 13, the server program makes the CPU 10 send the Web contents 15 designated by the URL to the client computer 2 from which the message has been transmitted. Likewise, when the message transmitted from the client computer 2 designates a class file 16 of the Java applet stored in the hard disk 13, the server program makes the CPU 10 return the designated class file 16 to the client computer 2 from which the message has been transmitted. On the other hand, when the message has been prepared in a predetermined format, the server program requests various application programs Via an CG1 (Common Gateway Interface) to perform the processing according to the contents of the message. Thereafter, when receiving the result of the processing from the application program that have received the request, the server program sends the result of the processing to the client computer 2 that has transmitted the message. One of the various application programs retrieves and updates a management analysis database 17, which is described later. Accordingly, the function that is provided as a whole by the server program, the API, and the application programs is called hereinafter a “management analysis server 14”.

In addition, various data stored in the hard disk 13 include the aforementioned class file 16 of the Java applet, the Web contents 15, the management analysis database 17 as well as a plurality of evaluation factor axis tables 18.

The class file 16 of the Java applet is executed in the client computer 2 for performing distributed processing with the functions of the management analysis server 14 for retrieving and updating the management analysis database 17.

The Web contents 15 include a HTML document (hereinafter referred to as the “Java definition document”) in which the class file definition of the class file 16 and the definition of an execution region for the Java applet are described.

The management analysis database 17 is a multi-dimensional database for defining and storing the position of data in a multi-dimensional logical space defined by a plurality of axes for indicating criteria. Now, the configuration of the management analysis database 17 and the meaning of the information stored therein are detailed in the following.

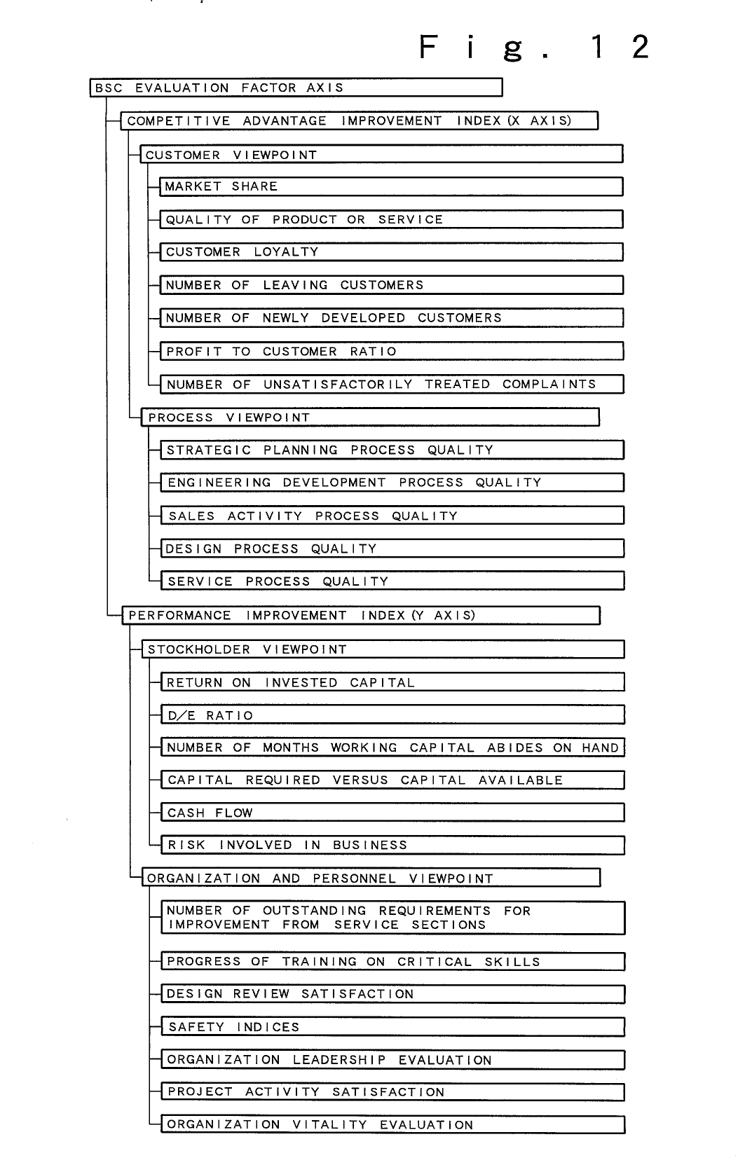

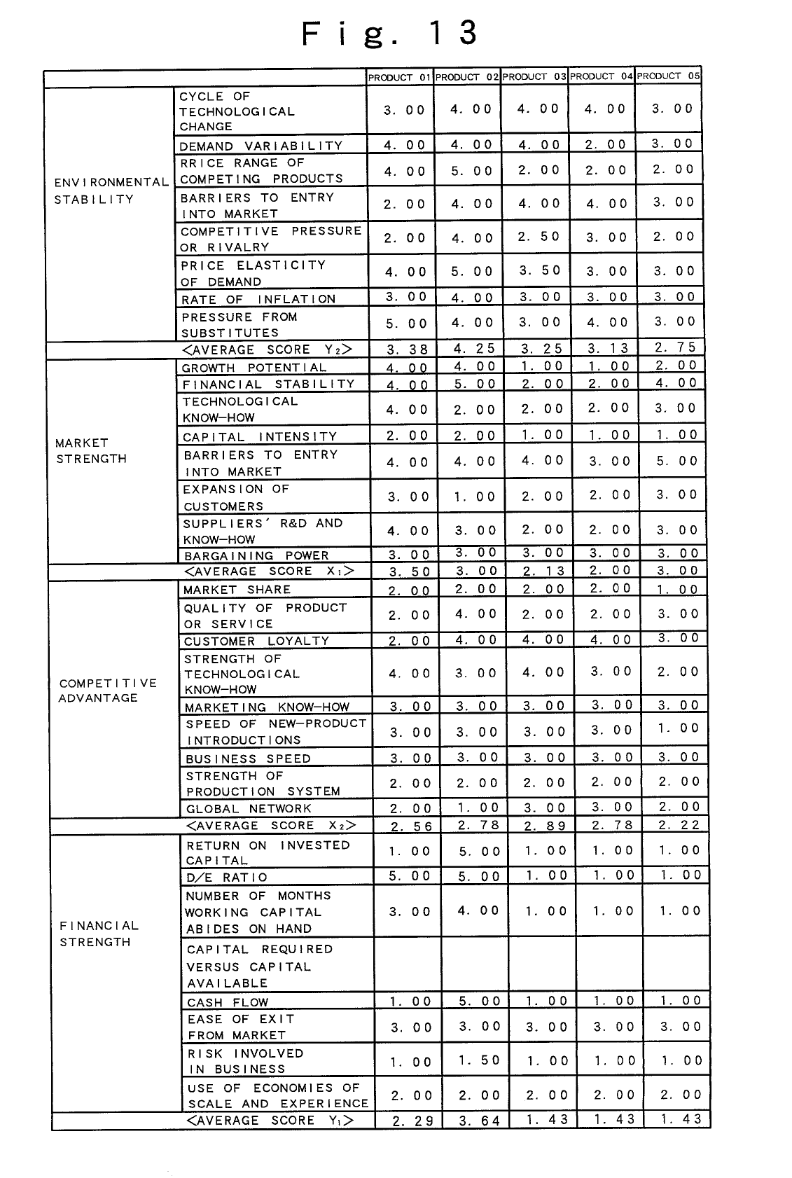

There is a plurality of “evaluation factor axes”, which are the most basic axes, in the management analysis database 17. One of them is a PPM evaluation factor axis shown in FIG. 11 and another one is a BSC evaluation factor axis shown in FIG. 12. The plurality of “evaluation factor axes” exists logically on the same straight line, so that they do not intersect with each other. More specifically, the PPM evaluation factor axis defines the storage position of data that is used for an analytical technique corresponding to the aforementioned SPACE. On the other hand, the BSC evaluation factor axis defines the storage position of data that is used for performing management analysis by means of the BSC (Balanced Score Card).

First, the data of which storage position is defined by the PPM evaluation factor axis are explained. It is to be understood herein that a set of plural pieces of information which have the same values on all other axes than the evaluation factor axes but have different values only on the PPM evaluation factor axis is called a “data set”. It is also to be understood that a region where one data set is stored, in other words, a region of which whole position is identified by respective axes other than evaluation factor axes and of which inner position is identified by the PPM evaluation factor axis is called one “entry”.

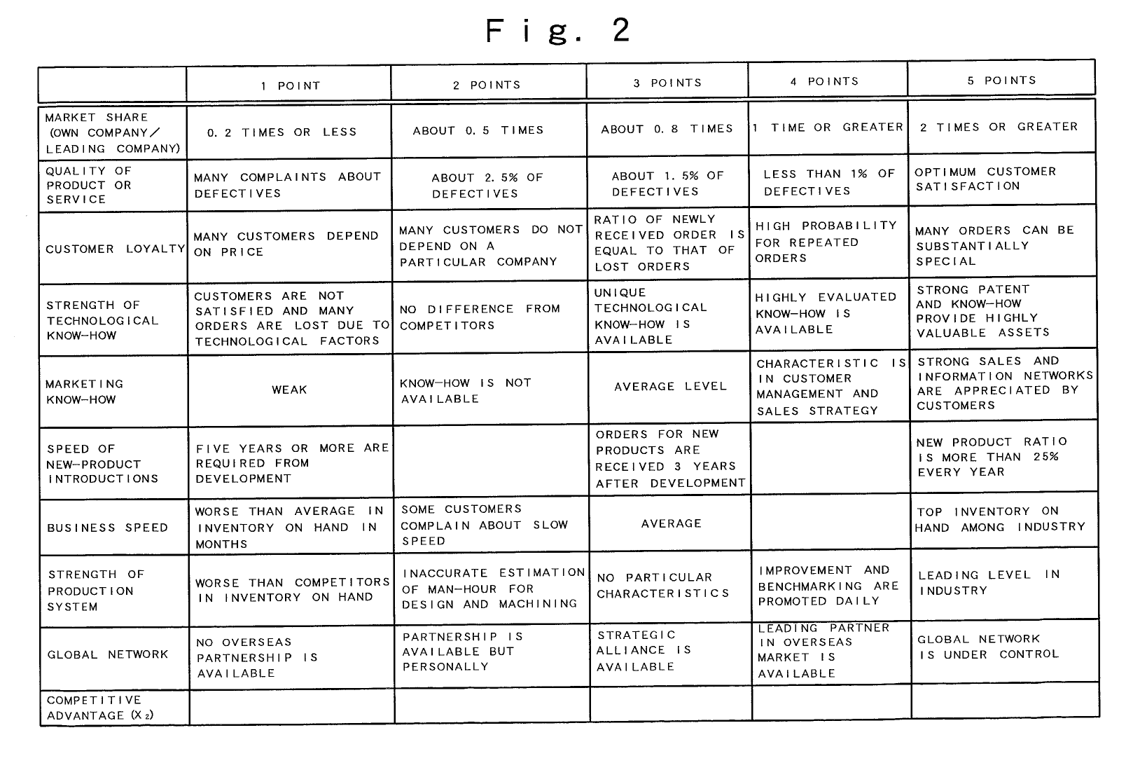

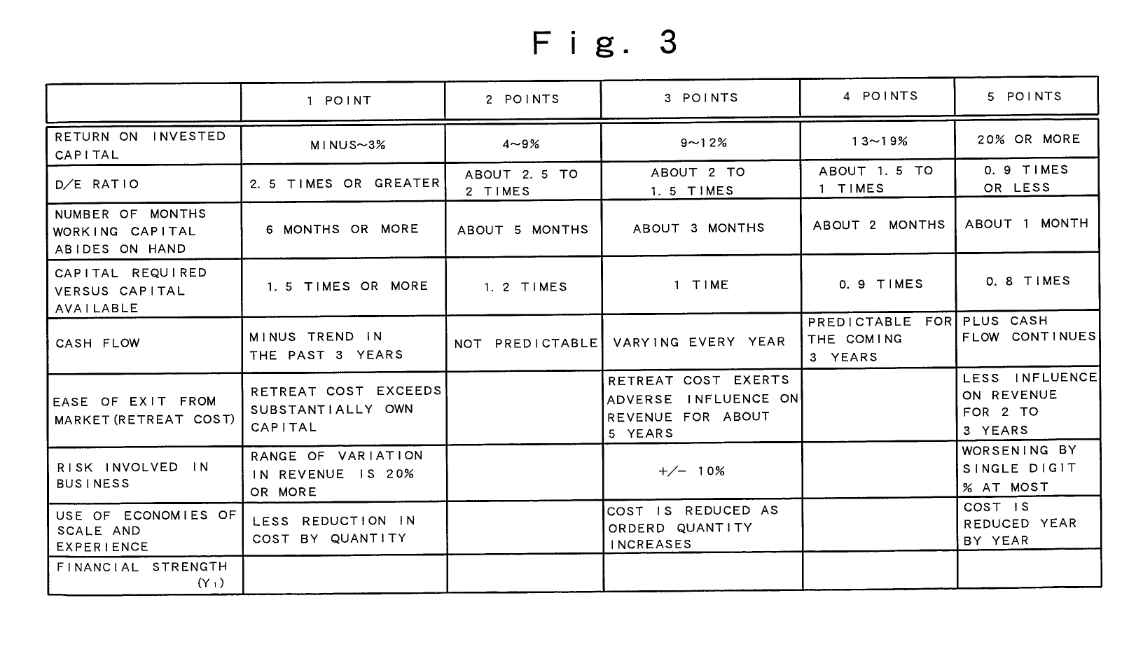

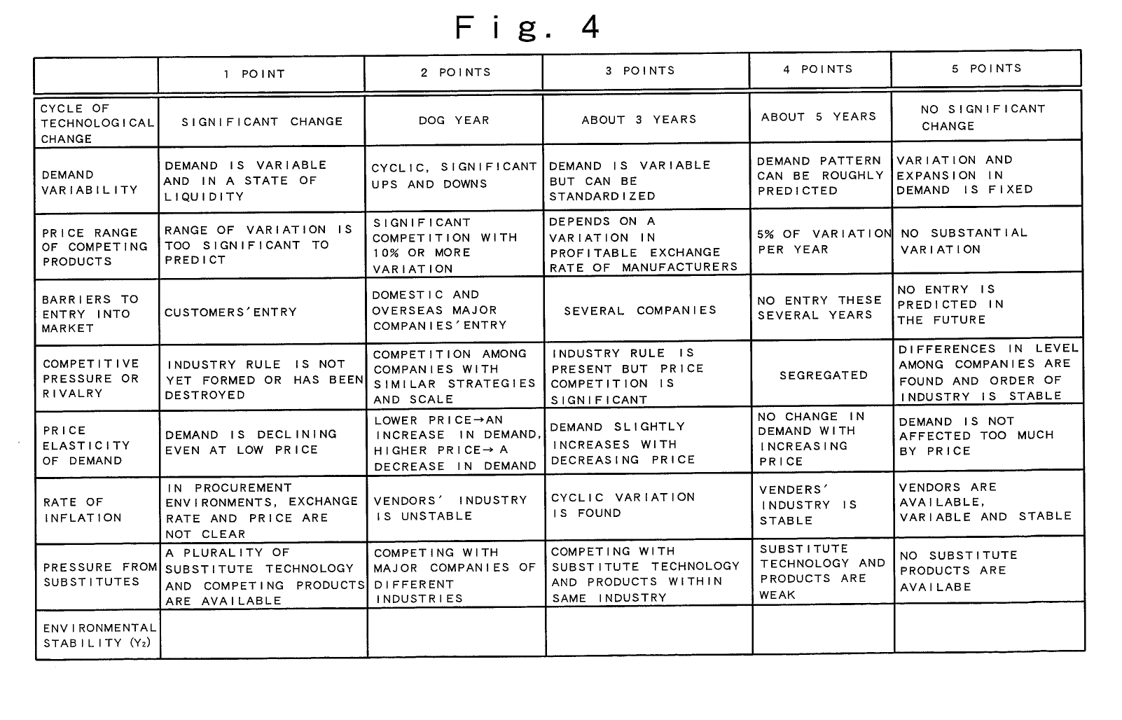

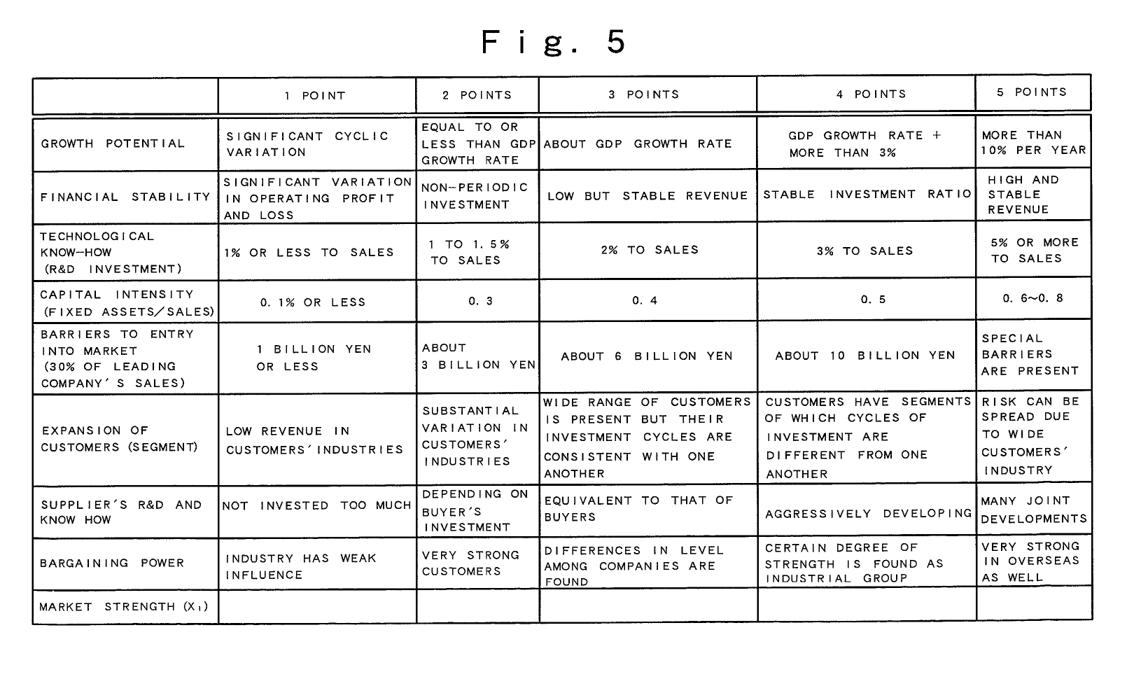

Each entry stores, as the data set, a plurality of evaluation scores of 1 to 5, respectively given to nine evaluation factors determining “competitive advantage” of the analyzed business unit shown in FIG. 2, (the factors being market share, quality of product or service, customer loyalty, strength of technological know-how, marketing know-how, speed of new-product introductions, business speed, strength of production system, and global network), to eight evaluation factors determining “financial strength” of the analyzed business unit shown in FIG. 3, (the factors being return on invested capital, D(debt)/E(equity capital) ratio, number of months working capital abides on hand, capital required versus capital available, cash flow, ease of exit from market (i.e. retreat cost), risk involved in business, and use of economies of scale and experience), to eight evaluation factors determining “environmental stability” of the analyzed business unit shown in FIG. 4, (the factors being cycle of technological changes, demand variability, price range of competing products, barriers to entry into market, competitive pressure or rivalry, price elasticity of demand, rate of inflation, and pressure from substitutes), and to eight evaluation factors determining “market strength” of the analyzed business unit shown in FIG. 5, (the factors being growth potential, financial stability, technological know-how (i.e., R & D investment), capital intensity (i.e., fixed assets versus sales), barriers to entry into market (30% of leading company's sales), expansion of customers (segments), suppliers' R & D and know-how, and bargaining power). Incidentally, the criteria for giving evaluation scores to each of the evaluation factors are shown in FIGS. 2 to 5, respectively.

As shown in each of the drawings, most evaluation factors are roughly evaluated by evaluators from their personal point of view. However, the evaluation factor “marketshare” is given an evaluation score corresponding to

$$\frac{\text{sales in the analyzed business unit}}{\text{leading company's sales in the same business}}$$

Likewise, the evaluation factor “return on invested capital” is given an evaluation score corresponding to

$$\frac{\text{Operating profit of the analyzed business unit}}{\text{equity capital} + \text{liability with interest}}$$

Likewise, the evaluation factor “number of months working capital abides on hand” is given an evaluation score corresponding to

$$\frac{\begin{matrix}credit receivable + inventories + advance payment - \\ trade accounts payable - advance received\end{matrix}}{monthly average sales}$$

Furthermore, the evaluation factor “cash flow” is given here an evaluation score corresponding to

(after-tax profits+depreciation expenses)−equipment investment

Furthermore, the evaluation factor “growth potential” is given an evaluation score in view of the coming five years. Furthermore, the evaluation factor “bargaining power” is given an evaluation score based on whether the analyzed business unit has strength of voice in establishing, de fact standards or specifications, compared with customers and venders.

The aforementioned data sets stored in the management analysis database 17 with logically overlapped with each other in directions of respective axes other than the evaluation factor axes. More specifically, the respective axes other than the evaluation factor axes are the organization axis, year axis, period axis, plan-result axis, and evaluator axis.

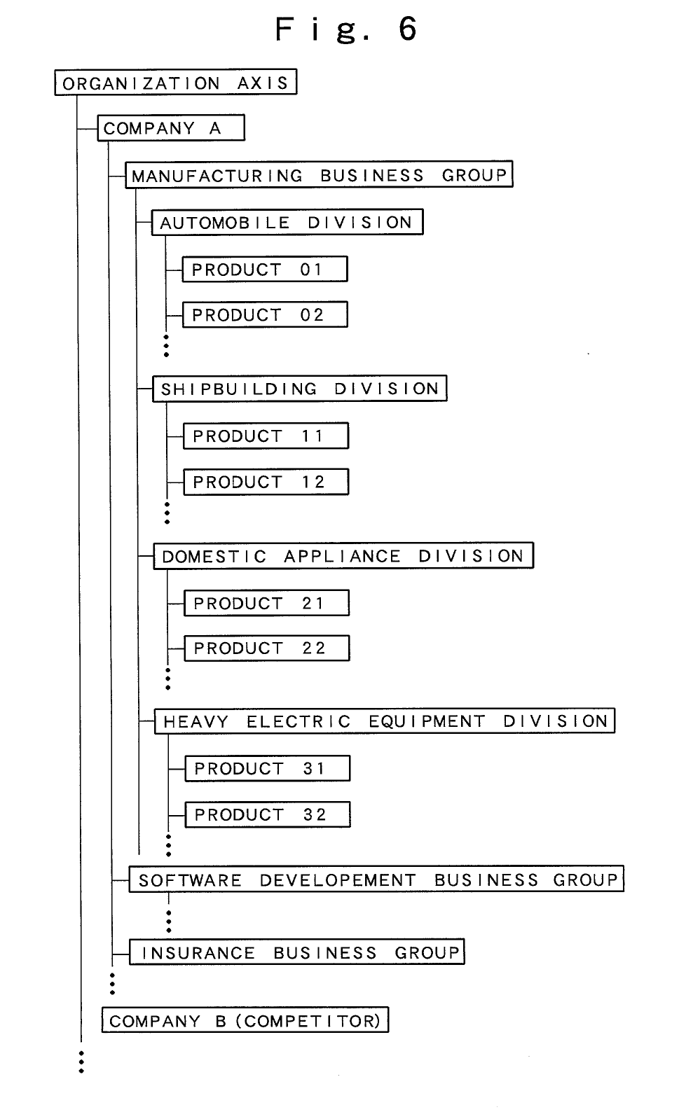

FIG. 6 is view of a tree showing the configuration of the organization axis. As shown in FIG. 6, the organization axis has individual business groups, individual divisions included in each of individual business groups, and individual names of products handled by each of the individual divisions, arranged thereon in series with each other, for every company including an analyzed company (company A in the example of FIG. 6). In addition, the elements showing the individual business units arranged on the organization axis forms a layered configuration in which the individual business groups exist in the layer subjacent to the individual companies; the individual divisions exist in the layer subjacent to the individual business groups; and the individual products exist in the layer subjacent to the individual divisions. That is, in the management analysis database 17, there exist data sets for individual products, data sets for the individual divisions forming the upper layer thereof, data sets for the individual groups forming the further upper layer thereof; and data sets for the individual companies in the still further upper layer thereof. Incidentally, it may be adoptable that the elements in the layers upper than that of the products are not provided with their own data sets, and the average value of the data sets in the layer subjacent thereto is automatically calculated to serve as a data set of the elements in the upper layer.

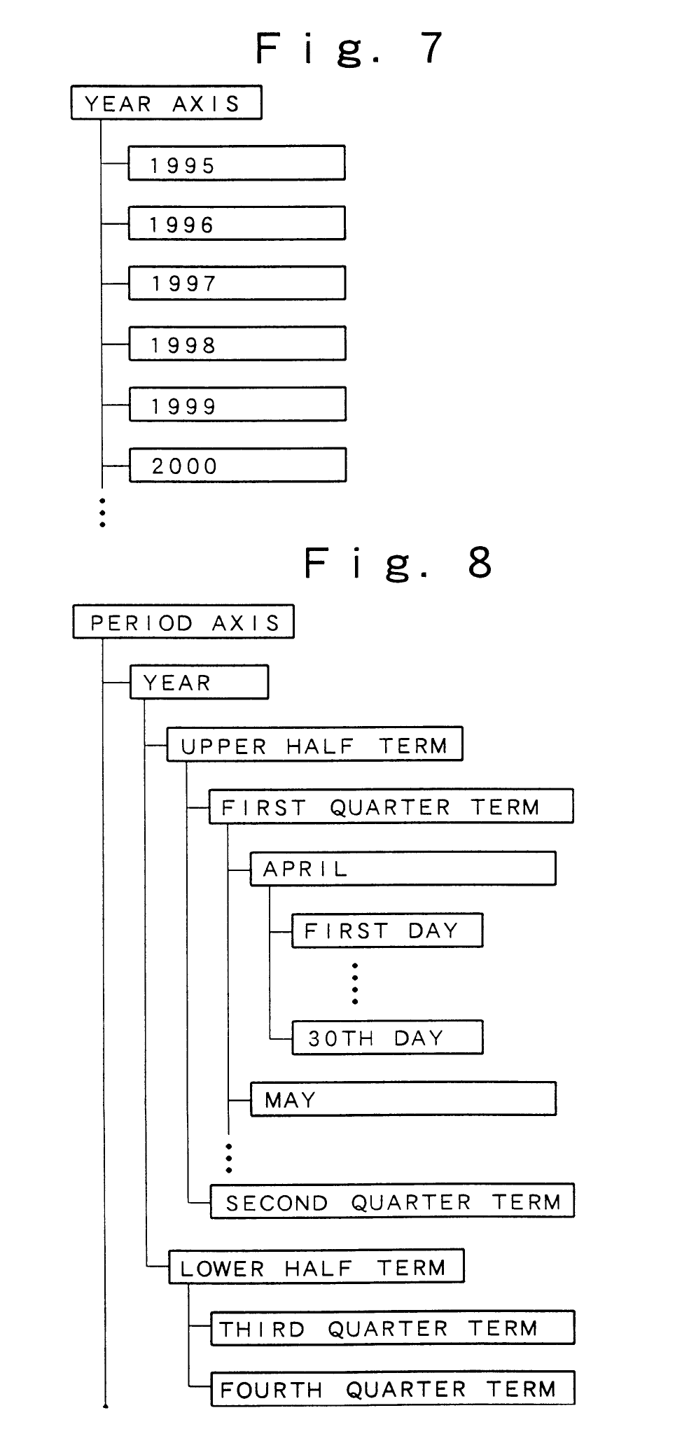

FIG. 7 is a view of a tree showing the configuration of the year axis. The year axis specifies the range of an evaluation value over time, with the period axis. On the year axis, individual years are arranged in series with one another as shown in FIG. 7.

FIG. 8 is a view of a tree showing the configuration of the period axis. The period axis specifies the range of an evaluation value over time, with the year axis. On the period axis, half terms given by dividing each year into halves, quarter terms given by further dividing each half term into halves, months in each quarter term, and days in each month are arranged in series with one another as shown in FIG. 8. In addition, each of the elements arranged on the period axis forms a layered configuration in which half terms exist in the layer subjacent to the years, quarter terms exist in the layer subjacent to respective half terms, months exist in the layer subjacent to respective quarter terms, and days exist in the layer subjacent to respective months. A multiple of data sets for individual business units exist at the same time from past to present in a chronological order in the management analysis database 17. Each of the data sets is located at a position corresponding to one of the days in the lowermost layer of the period axis. However, a data set for the same business unit needs not necessarily to exist for each of all days, which are the minimum unit of the time axis. This is because an average evaluation value of each data set for each of the evaluation factors is calculated to be utilized in practice in months, quarter terms, half terms or years, which belong to the upper layers than that of days.

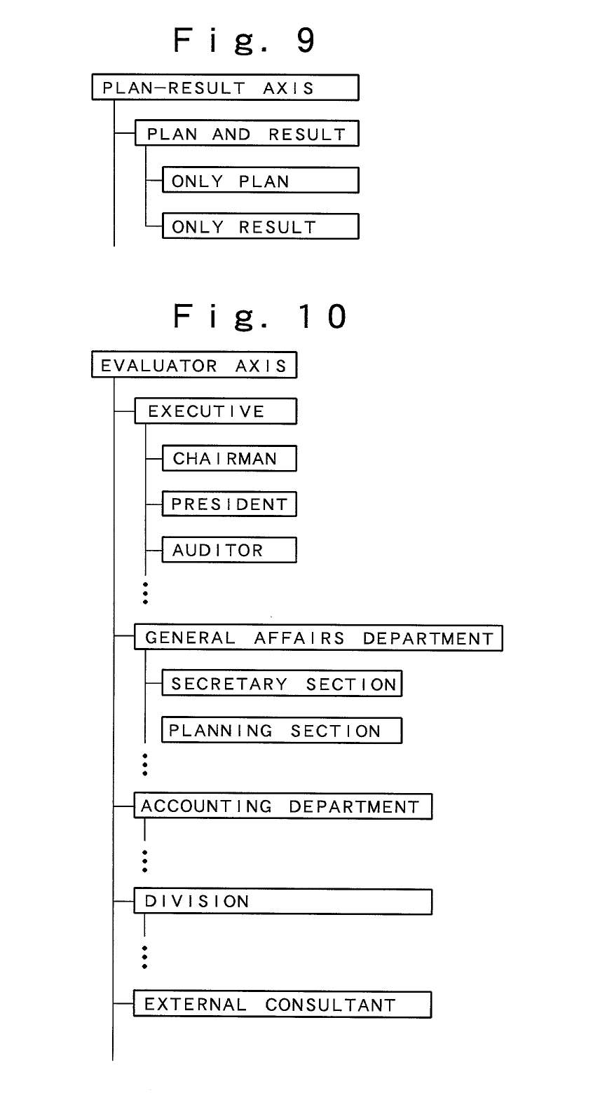

FIG. 9 is a view showing a tree of the configuration of the plan-result axis. As shown in FIG. 9, the plan-result axis has the lower layer of respective elements of plans and results and the upper layer of one element of plans and results, arranged in series with each other. A data set of plan values and a data set of results exist at the same time for every business unit in the management analysis database 17.

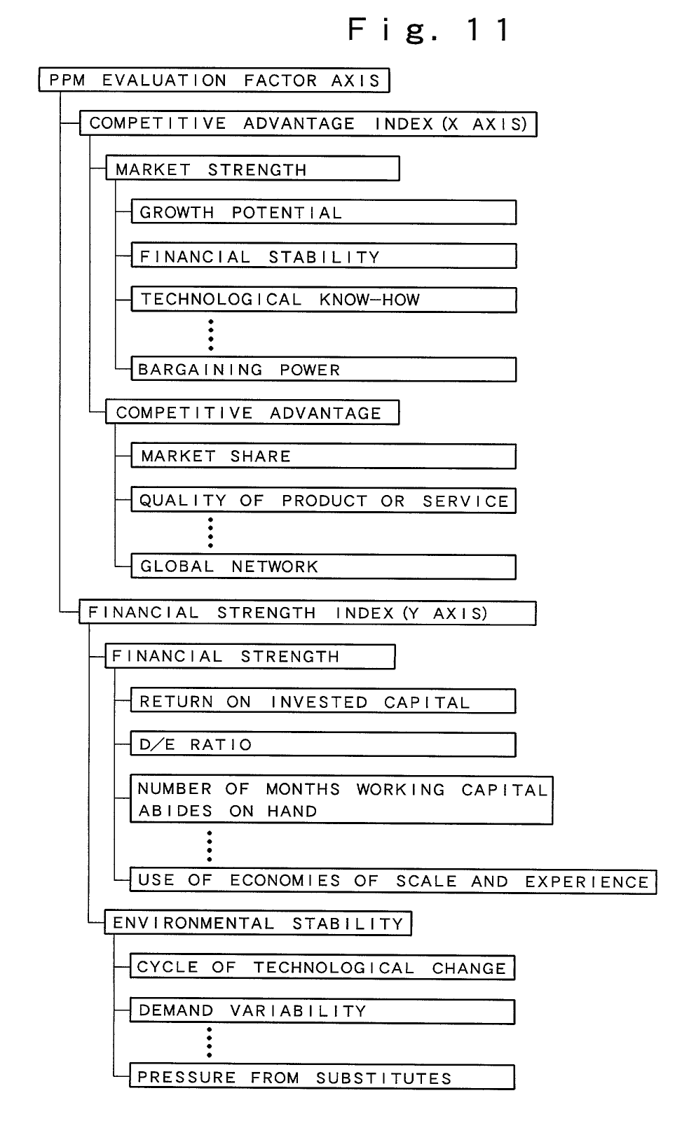

FIG. 10 is a view of a tree showing the configuration of the evaluator axis. As shown in FIG. 10, the evaluator axis has individual evaluators' names, grouped in their departments (evaluation departments) which belong to the upper layer thereof, arranged in series with each other. If a plurality of evaluators is present, data sets of individual business units exist at the same time for every evaluator in the management analysis database 17.

To summarize the foregoing, a plurality of data sets for the same business unit present on the organization axis exist logically overlapped with one another along the year axis, the period axis, the plan-result axis, and the evaluator axis, respectively, in the management analysis database 17. These axes can be added every time a new method for classifying evaluation values is established.

Incidentally, the aforementioned PPM evaluation factor axis is for identifying a position of data (that is, an evaluation factor) in each entry, on which individual evaluation factor names are classified into market strength, competitive advantage, financial strength and environmental stability, which are in the upper layer of the individual evaluation factors. Moreover, the industrial strength and competitive advantage are classified into the competitive advantage index (X-axis) of the upper layer thereof, and the financial strength and the environmental stability are classified into the financial strength index (Y-axis). Thus, these are arranged in series with one another on the PPM evaluation factor axis. Accordingly, it is possible to extract a part of the evaluation factors in each data set by specifying the position thereof on the PPM evaluation factor axis.

Now, data of which storage position is defined by the BSC evaluation factor axis are explained below. It is also to be understood here that a set of plural pieces information which have the same values on all other axes than the evaluation factor axes but have different values only on the BSC evaluation factor axis is referred to as a “data set”. In addition, it is to be understood that a region where one data set is stored, in other words, the region of which whole position is identified by respective axes other than evaluation factor axes and of which inner position is identified by the BSC evaluation factor axis is called an “entry”.

Each entry has stores, as the data set, a plurality of evaluation scores of 1 to 5 respectively given to a plurality of evaluation factors of the following viewpoints. The evaluation factors related to customer viewpoints include market share, quality of product or service, customer loyalty, the number of leaving customers, the number of newly developed customers, profit to customer ratio, and the number of unsatisfactorily treated complaints. The evaluation factors related to process viewpoints include strategic planning process quality, engineering development process quality, sales activity process quality, design process quality, and service process quality. The evaluation factors related to stockholder viewpoints include return on invested capital, D/E ratio, number of months working capital abides on hand, capital required versus capital available, cash flow, and risk involved in business. The evaluation factors related to organization and personnel viewpoints include the number of outstanding requirements for improvement from service sections, progress of training on critical skills, design review satisfaction, safety indices, organization leadership evaluation, project activity satisfaction, and organization vitality evaluation. Evaluation scores are given in accordance with the evaluation guidelines defining: one point for significant failure to attain targets being a main cause to worsen performance; two points for slight worsening with many problems; three points for no noticeable changes in target plans; four points for slight improvement but not contributing to performance; and five points for achievement of targets with substantial improvement.

In use of the BSC, business activities are followed up in terms of the aforementioned four viewpoints to improve operation. In this case, evaluation values for the respective evaluation factors related to the four viewpoints are summarized to display the positions of balances between targets and results for the respective analysis objects and balances in satisfaction between interested parties such as shareholders and employees. Moreover, in use of the BSC, a plurality of analysis objects are arranged in the same portfolio map, thereby enabling one to overlook the level of improvement of a whole company or business unit, which helps in extracting common challenges to review guidelines for propelling company's transformation and for evaluating achievement.

The foregoing data sets are present in the management analysis database 17 with logically overlapped with one another in directions of the aforementioned organization axis, year axis, period axis, plan-result axis, and evaluator axis, respectively.

As shown in FIG. 12, the BSC evaluation factor axis is for identifying a position of data (that is, an evaluation factor) in each entry, on which respective evaluation factor names arranged in series with one another and classified into the customer viewpoint, process viewpoint, shareholder viewpoint, and organization/training viewpoint, which are all in the upper layer thereof. Moreover, the customer viewpoint and the process viewpoint are classified into the competitive advantage improvement index (X axis), which is in the upper layer thereof, and the shareholder viewpoint and organization and personnel viewpoint are classified into the performance improvement index (Y axis), which is in the upper layer thereof. Accordingly, it is possible to extract a part of the evaluation factors in individual data sets by specifying the position thereof on the BSC evaluation factor axis.

Respective evaluation factor axis tables 18 stored in the hard disk 13 define factors and a layered configuration of each evaluation factor axis (i. e., the PPM evaluation factor axis, the BSC evaluation factor axis, and so on).

Approach of business analysis with the business position display system

An approach of business analysis in use of the management analysis database 17 having the configuration described above is outlined below. Incidentally, data that are related to respective evaluation factor axes are stored in a unified format in the management analysis database 17 so as to undergo the same processing, and therefore data related to the PPM evaluation factor axis are explained below as a typical example.

Moreover, for simplicity of explanation, it is assumed that analysis is performed as to a plurality of certain products (product 01-05), based on all evaluation factors of five data sets that are obtained by certain evaluators (certain evaluators on the evaluator axis) evaluating the results (results on a plan-result axis) with respect to those products at present (a certain point of time on a year axis and a period axis).

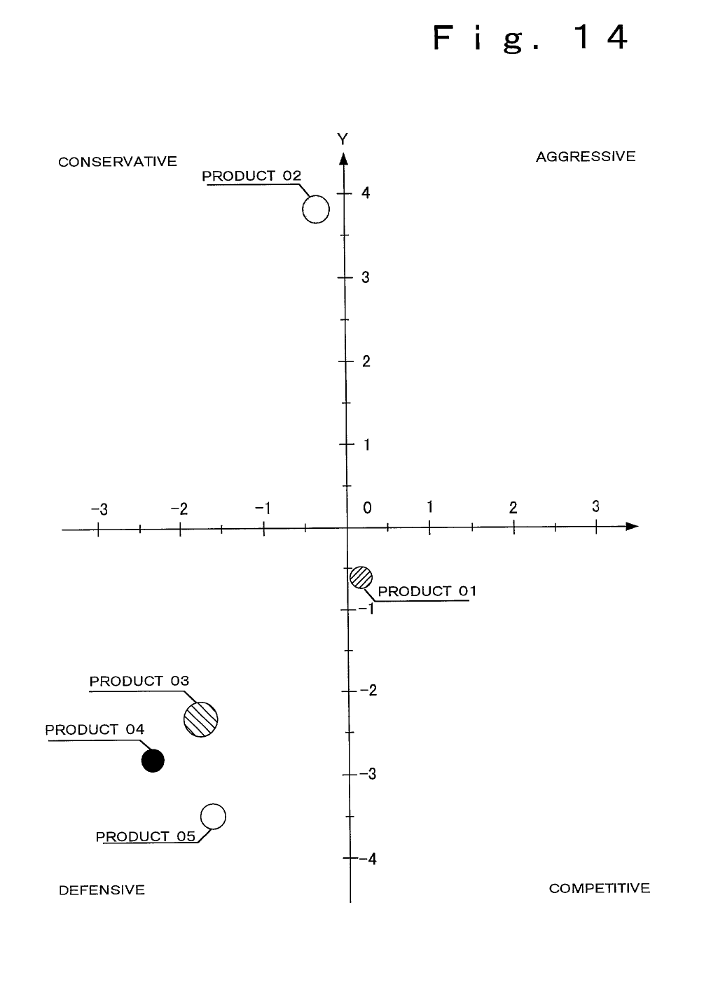

FIG. 13 shows a table listing specific values of the five data sets corresponding to the respective products (product 01-product 05). As shown in FIG. 13, the evaluation values for respective evaluation factors in the individual data sets are classified into the four groups of environmental stability, market strength, competitive advantage, and financial strength. Then, an average value of eight evaluation values that have been classified into the environmental stability is calculated to be substituted into an average score Y₂. Likewise, an average value of eight evaluation values that have been classified into the market strength is calculated to be substituted into an average score X₁. Likewise, an average value of eight evaluation values that have been classified into the competitive advantage is calculated to be substituted into an average score X₂. Likewise, an average value of eight evaluation values that have been classified into the financial strength is calculated to be substituted into an average score Y₁. Although, each average score was calculated by simply averaging respective evaluation values in this embodiment, the respective evaluation values may be weighted to determine weighted averages. In this case, for example, weights may be set to individual business units as objects of analysis.

Next, the following operations (1), (2) are performed on the respective average score X₁, X₂, Y₁, and Y₂ to calculate coordinate values (X-coordinate and Y-coordinate) on a portfolio map (which corresponds to a multi-dimensional space).

X=2X₁+2(X₂−6) (1)

Y=2Y₁+2(Y₂−6) (2)

In the example of FIG. 13, coordinates (0.11,−0.68) for product 01, coordinates (−0.44,3.79) for product 02, coordinates (−1.97,−2.64) for product 03, coordinates (−2.44,−2.89) for product 04, and coordinates (−1.56,−3.64) for product 05 are calculated, respectively.

As shown in FIG. 14, in this embodiment, the portfolio map is represented as a two-dimensional space that is defined by the orthogonal coordinates having the X-axis and the Y-axis being orthogonal to each other. Moreover, the aforementioned respective products are indicated by objects (which are represented as bubbles) having no directional meaning at the positions designated by the coordinates calculated for each of the products. Incidentally, the diameter of each object (that is, a bubble) shows one arbitrarily selected among the sales of corresponding product, investment for corresponding product, personnel scale for corresponding product, economically added value of corresponding product, etc. Accordingly, it is to be understood that data sets, for individual business units, stored in the aforementioned management analysis database 17 are provided with these sales, investment, personnel scale, or economically added value. Moreover, on the portfolio map, a leader line is drawn from each object (that is, bubble), and a character string that indicates the corresponding product is annexed to the leader line.

As can be understood from the aforementioned operation (1), the X-axis of the portfolio map is a scale (which is called competitive advantage index) for representing the relationship between the market strength (X₁) and the competitive advantage (X₂), indicating greater profit with increasing values in the positive direction. Accordingly, it can be understood that profit can be ensured if the industry is growing and the product (that is, the analyzed business unit) has technological complexity, even when the product (that is, the analyzed business unit) is less competitive. On the other hand, it can also be understood that a less competitive product (that is, an analyzed business unit) cannot ensure profit when the growth of the industry slows down.

In addition, as can be understood from the aforementioned operation (2), the Y-axis of the portfolio map is a scale (which is called financial strength index) for representing the relationship between the environmental stability (Y₂) and the financial strength (Y₁), indicating greater profit with increasing values in the positive direction. Accordingly, it can be understood that the business (that is, the analyzed business unit) can enjoy profit even with a great amount of debt or low revenue when there is no change in the industry and no entry of competition. On the other hand, it can also be understood that a business (that is, an analyzed business unit) with a bad financial structure cannot enjoy profit when the market becomes more competitive.

Thus, a product (that is, an analyzed business unit) corresponding to an object (that is, bubble) which is present in the first quadrant (that is, the region with positive X and Y coordinates) can be expected to provide the greatest amount of revenue. It can be therefore analyzed that such strategies should be aggressively promoted as to increase the market share, to expand competence, and to carry out M&A and the best practice. In addition, a product (that is, an analyzed business unit) corresponding to an object (that is, bubble) which is present in the second quadrant (that is, the region with the positive Y coordinate and negative X coordinate) provides less sales due to low competitive advantage even with a good financial structure. Thus, it can be analyzed that such strategies should be employed as to reduce costs, to make an investment, to merge with other companies, to improve the efficiency of processes, and to develop new competence in order to increase competitive advantage. Moreover, a product (that is, an analyzed business unit) corresponding to an object (that is, bubble) which is present in the third quadrant (that is, the region with negative X and Y coordinates) is expected to provide no revenue at present. It can be therefore analyzed that such defensive strategies have to be employed as to transform business models (that is, to review the business structure), to transform the structure of costs, to cut assets, to enter into a strategic partnership with other company, and to retreat the business from the market. Moreover, a product (that is, an analyzed business unit) corresponding to an object (that is, bubble) which is present in the fourth quadrant (that is, the region with positive X coordinate and negative Y coordinate) is expected to provide gross profit because of competitive advantage thereof but not to ensure enough revenue due to a bad financial structure. It can be therefore analyzed that such strategies should be employed as to innovate production, to make the assets efficient, to reduce costs, and to enter into a partnership with or to acquire a cash-rich company.

As described above, according to the business position display system of this embodiment, a bubble chart is used as means for displaying the position of an analyzed business unit under business environments on a portfolio map. Thus, a plurality of objects (bubbles) can be displayed on the portfolio map at the same time. Accordingly, a plurality of products can be comparatively analyzed.

The example described above referring to FIGS. 13 and 14 shows a case that five objects (bubbles) are displayed on a portfolio map in accordance with five data sets for five products 01 through 05 which are distributed along the organization axis and which are located at a common position on all other axes.

Incidentally, when analysis is performed based on data related to the BSC evaluation factor axis, the X axis is a scale representing the relationship between the customer viewpoint (X₁) and the process viewpoint (X₂). In addition, the Y axis is a scale representing the relationship between the shareholder viewpoint (Y₁) and the organization/personnel viewpoint (Y₂). Like the PPM, positions of business units analyzed with the BSC on a portfolio map are displayed by the coordinates obtained by operations (1) and (2). Like the PPM, objects can be displayed as bubbles representing an arbitrary value such as of an investment scale, sales, or a personnel scale. Moreover, as to a single business unit, chronological changes and positions of planned targets can be displayed, and drilling down to lower organization units and rolling up to upper organization units are possible. In addition, a plurality of business units of a whole company can be displayed at the same time to allow an entire trend to be checked, thereby the total planning department of the company can set a total common improvement guideline to be carried out in the following term. In the case of the BSC, an analyzed business unit of which object is present in the first quadrant (that is, the region with positive X and Y coordinates) is evaluated such that its targets are attained and substantial improvement is achieved from all of the customer viewpoint, the stockholder viewpoint, the process viewpoint, and the organization and personnel viewpoint. If any one of the evaluation factors is given a relatively low evaluation score, basic guidelines are drawn up so as to improve the evaluation factor in the following term or to set and challenge a higher target. As to an analyzed business unit of which object is present in the second quadrant (that is, the region with negative X coordinate and positive Y coordinate), although an improvement is achieved with respect to the stockholder viewpoint, more specifically, financial performance evaluation and the organization and personnel viewpoint, some targets are not attained with respect to the customer viewpoint or the process competitive advantage. In this case, it is necessary to improve the relationship with customers or to make a substantial process innovation plan. As to an analyzed business unit of which object is present in the third quadrant (that is, the region with negative X and Y coordinates), all factors have problems and thus organizational operation needs to be radically reorganized. As to an analyzed business unit of which object is present in the fourth quadrant (that is, the region with positive X coordinate and negative Y coordinate), although targets are attained or an improvement is made in terms of competitive advantage, there are some problems in evaluation factors of the stockholder viewpoint and the organization and personnel viewpoint. Thus, it is necessary to innovate leadership to balance the financial management with the organizational motivation.

In this embodiment, it is also possible to display objects (bubbles) on a portfolio map in accordance with data sets which are obtained by retrieving the management analysis database 17 from an angle different from the one mentioned above. For example, it is also possible to display, on a portfolio map, the object (bubble) of an element (for example, an automobile division) present in the upper layer of product 01 through product 05 on the organization axis. In this case, when data sets, having a common position on other axes, related to the element (that is, the automobile division) in the upper layer are present in the management analysis database 17, the coordinates on the portfolio map are calculated to display the object (bubble) in accordance with the data sets. On the other hand, when no data sets related to the element (the automobile division) in the upper layer are available, all groups of data sets related to all the elements that belong to the immediately subjacent layer to the element (the automobile division) are read out and average values for respective evaluation factors are calculated based on these groups of data sets. Then, the coordinates on the portfolio map are calculated to display the object (bubble) in accordance with the data sets comprising the average values calculated for respective evaluation factors. It is referred to as rolling-up to switch, as mentioned above, from the state of displaying the object (bubble) related to an element that belong to a lower layer to the sate of displaying the object (bubble) related to an element present in the upper layer. On the contrary, it is referred to as “drilling-down” to switch from the state of displaying the object (bubble) related to an element present in an upper layer to the sate of displaying the object (bubble) related to an element present in the lower layer. For example, when a business unit (for example, a division) in an upper layer provides worsened revenue, such rolling-up and drilling-down will make it possible to identify the business unit (for example, a product) in the lower layer, which causes the revenue to be worsened.

In addition, for a certain analyzed business unit, it is also possible to display an object (bubble) on a portfolio map in accordance with a plurality of data sets which are distributed in a predetermined range on the year axis and have a common position on other axes. In this case, if an element “day” is designated on the period axis, coordinates on the portfolio map are calculated in accordance with respective data sets that are distributed along the period axis, and then the objects (bubbles) corresponding to respective data sets are displayed on the portfolio map. A series of objects (bubbles) displayed in this manner represent a change in position of the analyzed business unit by the day. In contrast, when an element designated on the period axis is an element in an upper layer such as a “month”, a plurality of data sets distributed in a predetermined range along the period axis are classified in the unit of an element designated. Then, average values for respective evaluation factors are calculated among the classified data sets and then objects (bubbles) are displayed on the portfolio map in accordance with the data sets comprising the average values calculated for the respective evaluation factors. A series of objects (bubbles) displayed in this manner represent a change in position of the analyzed business unit in the unit of the element designated. Displaying such a change in position of the analyzed business unit will help one know the life cycle of the analyzed business unit, thus enabling one to predict a change in the future and employ in advance countermeasures to take action against the change.

In addition, for a certain analyzed business unit, it is also possible to display on a portfolio map at the same time an object (bubble) indicating a planned position and an object (bubble) indicating an actual position of the analyzed business unit in accordance with respective data sets related to plans and results, distributed on the plan-result axis and having a common position on other axes. Thus, displaying will enable one to compare plans with results to know the level of accomplishing targets as well as to analyze what is lacking to achieve the targets.

Moreover, it is also possible to display objects (bubbles) on a portfolio map in accordance with a plurality of data sets distributed on the evaluator axis and having a common position on other axes. In this case, average values for respective evaluation factors are calculated based on a plurality of data sets that have been read out and then the coordinates of the analyzed business unit on the portfolio map are calculated in accordance with the data sets comprising the average values calculated for the respective evaluation factors. Then, objects (bubbles) corresponding thereto are displayed on the portfolio map. Thus, averaging the evaluations provided by a plurality of evaluators as such will make evaluation values free from biased viewpoints, thereby making the result of analysis more dependable. Furthermore, in this case, the aforementioned rolling-up and drilling-down are also made possible in accordance with a layered configuration on the evaluator axis. Accordingly, rolling-up and drilling down on the evaluator axis will enable one to know the difference in trend of evaluation among respective evaluators and respective evaluation sections, thereby making it also possible to correct data sets to improve the reliability of the data.

Furthermore, multi-aspect analysis can be performed by displaying the position of the same evaluated item interchangeably by the PPM and the BSC. FIG. 27 shows an comparative example of a position by the PPM (FIG. 27 (a)) and a position by the BSC (FIG. 27 (b)). It can be understood from this example that business unit A is positioned in the first quadrant by the PPM, being adapted for aggressive investment, whereas the business unit A is positioned in the second quadrant by the BSC, indicating the need of some innovation. This would lead the strategic manager, for example, to priory make investment for innovation rather than simple expanding investment.

Incidentally, in this embodiment, when one desires to know the specification of an object (bubble) displayed once on a portfolio map, respective average scores, based on which the object has been displayed, can be illustrated. Moreover, when one desires to know the specification of respective average scores, evaluation values of respective evaluation factors, based on which the average score has been calculated, can also be illustrated.

Contents of Processing of the Management Analysis Server

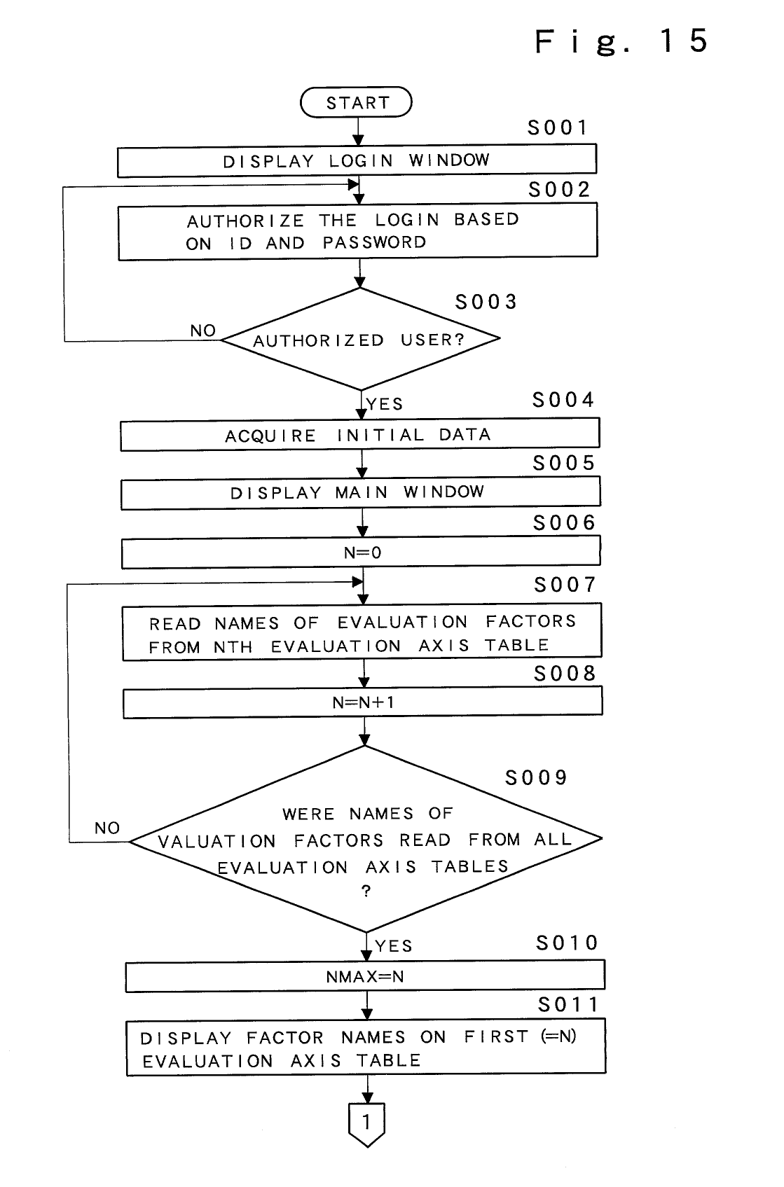

Now, explained are the contents of processing performed by the CPU 10 in accordance with the management analysis server 14 for implementing the aforementioned management analysis approaches. It is supposed in following explanation that an operator (an evaluator or an analyzer) transmits an URL of Java definition document from one of the client computers 2 to the host computer 1. Subsequently, the host computer 1 transmits the Java definition document to the client computer 2. Upon receiving the Java definition document, the Web browser 27 being executed in the client computer 2 ensures an area for executing the Java applet as well as requests the host computer 1 for the class file 16 of the Java applet. The host computer 1 transmits the requested class file 16 to the requesting client computer 2. After having received the class file 16, the Web browser 27 in the client computer 2 executes the Java applet 26. After having been thus started up, the Java applet 26 communicates with the management analysis server 14 in the host computer 1 to thereby execute the processing shown in FIGS. 15 to 21. In the following explanation, “depressing buttons”, “clicking”, “dragging”, “inputting”, and “writing” means that the contents of operation to the input device 23 of the client computer 2 are transmitted by the Java applet 26 and received by the management analysis server 14. In addition, in the following explanation, “displaying on the screen” means that the management analysis server 14 transmits, to the Java applet 26, the parameters necessary for the Java applet 26 to display a window or a dialog on the display 22.

In the first S001 in the processing of FIG. 15, the management analysis server 14 displays a login window on the display 22 of the client computer 2. AS shown in FIG. 23, the login window contains two text boxes (which are a user ID text box 30 and a password text box 31) to which a pair of a user ID and a password, which have been registered beforehand in the management analysis server 14, are to be written, respectively.

In the next S002, the management analysis server 14 determines whether or not the contents written into the user ID text box 30 and the password text box 31 of the log-in window are consistent with a pair of user ID and password, registered in advance therein, in order to check if the operator of the client computer 2 is an authorized user. In the S003 executed after a log-in button 32 has been clicked, the management analysis server 14 returns the processing to S002 in case the contents of both of the user ID text box 30 and the password text box 31 are inconsistent with none of the pairs of a user ID and a password registered therein. On the other hand, in case the contents of both of the user ID text box 30 and the password text box 31 are consistent with any one of the pairs of a user ID and a password registered therein, the management analysis server 14 judges that an authorized user has accessed and advances the processing to S004.

In the S004, the management analysis server 14 acquires the initial data required for displaying a main window, which is described later, on the display 22 of the client computer 2.

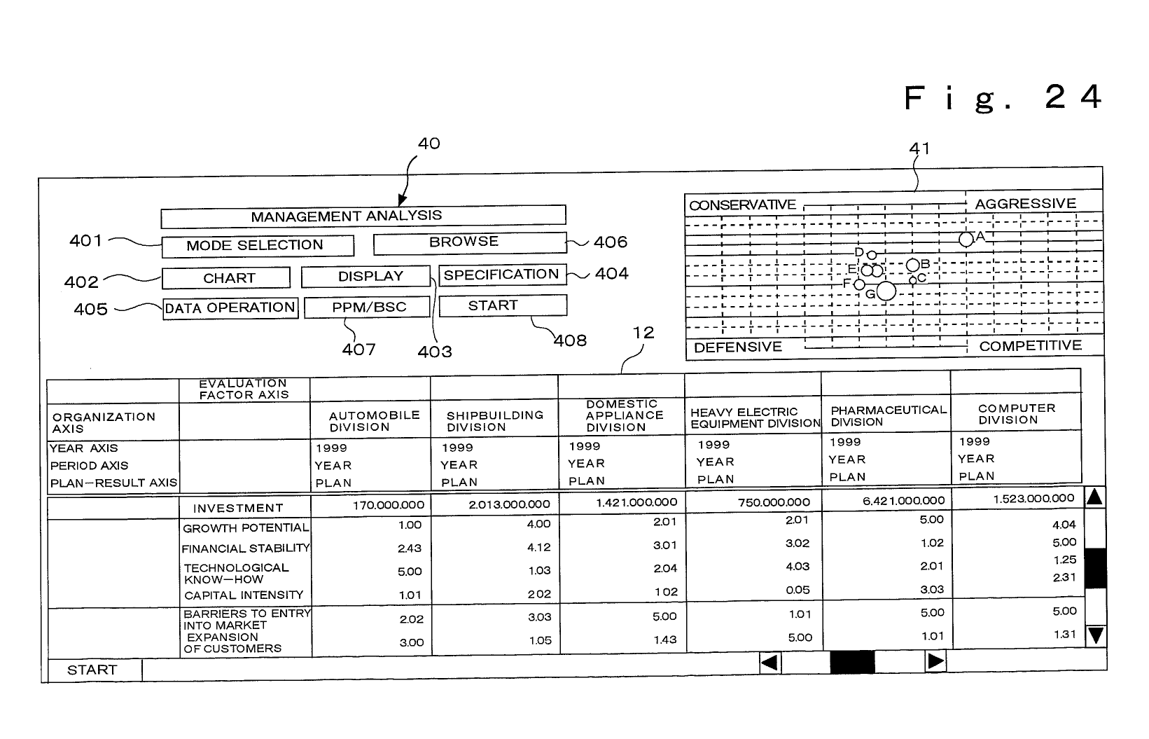

In the next S005, the management analysis server 14 displays the main window on the display 22 of the client computer 2 in accordance with the initial data acquired in the S004. As shown in FIG. 24, the main window is divided into an input buttons area 40 for displaying a current mode indicating column 406 and a plurality of buttons, i. e., a mode select button 401, a chart button 402, a display button 403, a specification button 404, a data operation button 405, a PPM/BSC switching button 407, and a start button 408; a map area 41 for displaying a portfolio map of which concept has already been explained referring to FIG. 14; and a list area 42 for listing the detail of respective analyzed business units whose object (bubble) is displayed on the portfolio map. Incidentally, respective analyzed business units are displayed in detail in a tabular form in the list area 42. Specifically, the header items of the list include extracting conditions (that is, the names of elements specified on respective axes) for extracting data sets related to respective analyzed business units out of the management analysis database 17 and the investment for the business units designated by the names of elements on the organization axis. The numerical values displayed in the list are average values for respective evaluation factors among all the data sets, related to individual analyzed business units, which are extracted from the management analysis database 17 in accordance with the aforementioned extracting conditions. However, names of elements on respective axes are not specified at the time of S007, so that the list area 42 displays only a frame.

In the next S006, the management analysis server 14 resets variable N, which tells the number of evaluation factor axes, to “1”.

In the next S007, the management analysis server 14 reads a series of names of evaluation factors from the Nth evaluation factor axis table 18.

In the next S008, the management analysis server 14 increments the variable N by one.

In the next S009, the management analysis server 14 checks whether or not series of names of evaluation factors have been read therein from all the evaluation factor axis tables 18. If the series of evaluation factors have not yet been read therein from all the evaluation factor axis tables 18, the management analysis server 14 returns the processing to the S007. On the other hand, if the series of evaluation factors have been read therein from all the evaluation factor axis tables 18, the management analysis server 14 advances the processing to S010.

In the S010, the management analysis server 14 substitutes the current variable N into variable Nmax which indicates the maximum value of N.

In the next S011, the management analysis server 14 re-sets the variable N to “1”, and then displays the evaluation factor names, which have been read in the S007 from the first (=N) evaluation factor axis table 18, as aforementioned header items in the list of the list area 42.

In the next S012, the management analysis server 14 accepts input through the start button 408 in the main window. In other words, the start button 408 is enabled to be clicked by the input device 23. Then, in the next S013, the management analysis server 14 checks whether or not the start button 408 has been depressed (clicked). If the start button 408 has not yet been depressed (clicked), the processing is returned to the S012. On the other hand, if the start button 408 has been depressed (clicked), the management analysis server 14 advances the processing to S014.

In the S014, the management analysis server 14 waits for the occurrence of a click event to the mode select button 401 in the main window. When a click event to the mode select button 401 has occurred, the management analysis server 14 displays a drop-down menu adjacent the mode select button 401 for selecting one from three modes (a browser mode, a simulation mode, and an edit mode). Subsequently, in the S009, the management analysis server 14 waits until one of the three modes listed in the drop-down menu is selected. When the browser mode is selected, the processing is advanced to browser mode processing (which will be detailed later) in S016. When the simulation mode is selected, the processing is advanced to simulation mode processing (which will be detailed later) in S017. When the edit mode is selected, the processing is advanced to edit mode processing (which will be detailed later) in S018. After the processing (S016, S017, and S018) has been completed, the management analysis server 14 returns the processing to the S014. Thereafter, the management analysis server 14 continues to repeat the loop processing of the S014-S018.

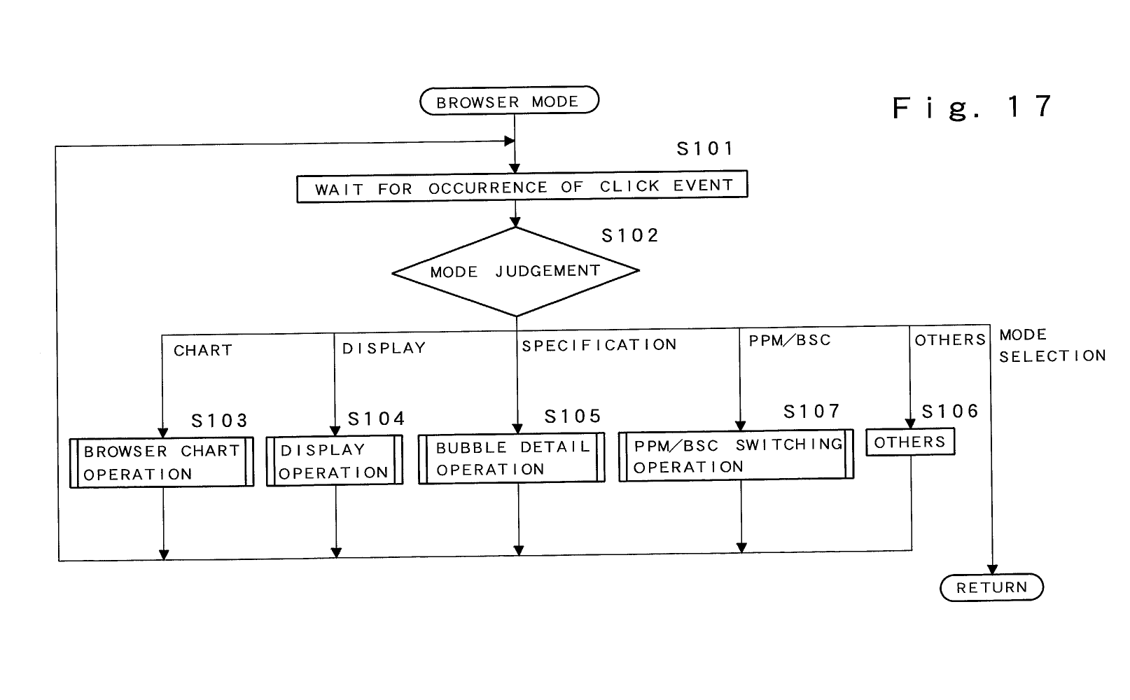

FIG. 17 is a flow chart showing the browser mode processing subroutine to be executed in the aforementioned S016. In the first step S101 of this subroutine, the management analysis server 14 displays characters “Browse” in the current mode indicating column 406 and thereafter waits for the occurrence of a click event. If a click event has occurred, the clicked button is determined in the next S102.

If it is determined in the S102 that the chart button 402 has been clicked, the management analysis server 14 executes browser chart operation processing in S103. The browser chart operation processing is to set extracting conditions for the management analysis database 17 (that is, the range of element names on respective axes) and display conditions for portfolio maps (that is, items to be related to the diameter of bubbles).

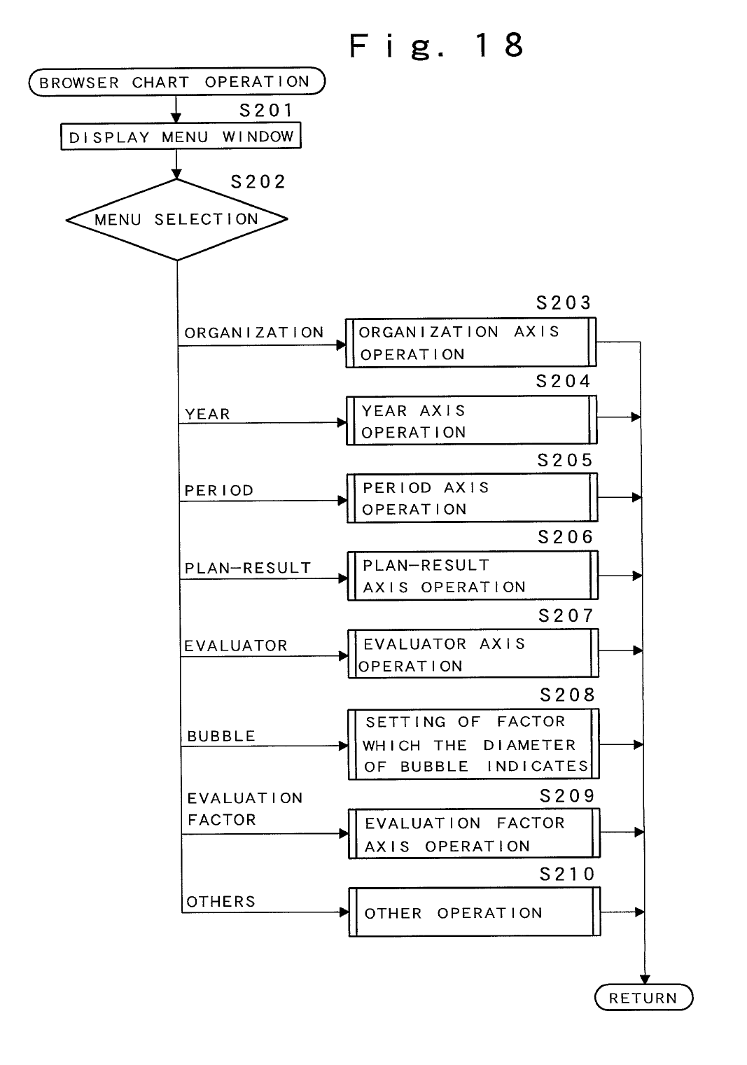

FIG. 18 is a flow chart showing the contents of the browser chart operation processing subroutine to be executed in the S103. In the first step S201 of the subroutine, the management analysis server 14 displays a menu window (not shown) listing a plurality of options (that is, “Organization”, “Year”, “Period”, “Plan-result”, “Evaluator”, “Bubble”, “Evaluation Factor”, etc.), with it superimposed on the main window. Subsequently, in S202, the management analysis server 14 waits until one of the options in the menu window is selected. When the “Organization” is selected, then the processing is advanced to S203. When the “Year” is selected, then the processing is advanced to S204. When the “Period” is selected, then the processing is advanced to S205. When the “Plan-result” is selected, then the processing is advanced to S206. When the “Evaluator” is selected, then the processing is advanced to S207. When the “Bubble” is selected, then the processing is advanced to S208. When the “Evaluation Factor” is selected, then the processing is advanced to S209. When another alternative is selected, then the processing is advanced to S210.

In the S203, the management analysis server 14 executes organization axis operation processing. More specifically, the management analysis server 14 displays a list box illustrating the organization axis in the form of a tree shown in FIG. 6, with it superimposed on the main window. Among the respective element names (nodes) displayed in the list box, those set as the current extracting conditions are highlighted. When an element name is clicked by the operator of the client computer 2, the newly clicked element name is set as an extracting condition and highlighted. Moreover, the element name that has been highlighted at that time is released from the extracting condition and displayed back in a normal color. However, when an element name is clicked while a specific key (for example, Ctrl key) is being depressed, the element name that has been highlighted at that time remain as the extracting condition and the newly clicked element name is added as the extracting condition and highlighted. When a plurality of element names are dragged, all the element names contained in the range dragged are selected as extracting conditions and highlighted. The aforementioned rolling-up means clicking element names in the upper layer of the element names that have been set as the current extracting conditions in the list box. On the other hand, the aforementioned drilling-down means dragging all element names that belong to the layer immediately subjacent to the element names that have been set as the current extracting conditions in the list box. When the operator of the client computer 2 closes the list box, the management analysis server 14 ends the browser chart operation processing subroutine to return the processing to FIG. 17.

Furthermore, in the S204, the management analysis server 14 executes year axis operation processing. More specifically, the management analysis server 14 displays a list box illustrating the organization axis in the form of a tree shown in FIG. 7, with it superimposed on the main window. Among the respective element names displayed in the list box, those set as the current extracting conditions are highlighted. In addition, the same setting of extracting conditions as in the S203 is carried out in the list box. When the operator of the client computer 2 closes the list box, the management analysis server 14 ends the browser chart operation processing subroutine to return the processing to FIG. 17.

In the S205, the management analysis server 14 executes period axis operation processing. More specifically, the management analysis server 14 displays a list box illustrating the period axis in the form of a tree shown in FIG. 8, with it superimposed on the main window . Among the respective element names (nodes) displayed in the list box, those set as the current tallying conditions are highlighted. When an element name is clicked by the operator of the client computer 2, the newly clicked element name is set as a tallying condition and highlighted. Moreover, the element names that have been highlighted at that time are released from the tallying conditions and displayed back in a normal color. However, in the S205, unlike the aforementioned S203 and S204, a plurality of element names cannot be set as the tallying condition at the same time. When the operator of the client computer 2 closes the list box, the management analysis server 14 ends the browser chart operation processing subroutine to return the processing to FIG. 17.

In the S206, the management analysis server 14 executes plan-result axis operation processing. More specifically, the management analysis server 14 displays a list box illustrating the plan-result axis in the form of a tree shown in FIG. 9, with it superimposed on the main window. Among the respective element names (nodes) displayed in the list box, those set as the current extracting conditions are highlighted. When an element name is clicked by the operator of the client computer 2, the newly clicked element name is set as an extracting condition and highlighted. Moreover, the element names that have been highlighted at that time are released from the extracting conditions and displayed back in a normal color. When the operator of the client computer 2 closes the list box, the management analysis server 14 ends the browser chart operation processing subroutine to return the processing to FIG. 17.

In the S207, the management analysis server 14 executes evaluator axis operation processing. That is, the management analysis server 14 displays a list box illustrating the evaluator axis in the form of a tree shown in FIG. 10, with it superimposed on the main window. Among the respective element names (nodes) displayed in the list box, those set as the current extracting conditions are highlighted. Moreover, the same setting of extracting conditions as in the S203 is carried out in the list box. When the operator of the client computer 2 closes the list box, the management analysis server 14 ends the browser chart operation processing subroutine to return the processing to FIG. 17.

In the S208, the management analysis server 14 executes setting processing to define what the diameter of bubbles indicates. More specifically, the management analysis server 14 displays a list box listing the options, “Sales”, “Investment”, “Personnel Scale”, and “Economic Added Value”, with it superimposed on the main window. Among the respective options displayed in the list box, the one currently set as the factor which the diameter of bubble indicates is highlighted. When an option is clicked by the operator of the client computer 2, the newly clicked option is set as a factor indicated by the diameter of bubble and highlighted. Moreover, the factor which has been highlighted at that time is released from the meaning of the diameter of the bubble and the alternatives are displayed back in a normal color. When the operator of the client computer 2 closes the list box, the management analysis server 14 ends the browser chart operation processing subroutine to return the processing to FIG. 17.

Furthermore, in the S209, the management analysis server 14 executes evaluation factor axis operation processing. More specifically, the management analysis server 14 displays a list box listing the evaluation factors on the evaluation factor axis corresponding to the current variable N in the form of a tree shown in FIGS. 11 and 12, with it superimposed on the main window. Among the respective evaluation factors listed in the list box, the one set as the current extracting condition is highlighted. Moreover, the same setting of extracting conditions as in the S203 is carried out for respective evaluation factors in the list box. When the operator of the client computer 2 closes the list box indicating these evaluation factors, the management analysis server 14 ends the browser chart operation processing subroutine to return the processing to FIG. 17.

Furthermore, in the S210, the management analysis server 14 executes the processing corresponding to the option clicked in the menu window at the S202, thereafter ends the browser chart operation processing subroutine to return the processing to the routine of FIG. 17.

In the routine of FIG. 17 to which the processing has returned, the management analysis server 14 returns the processing to the S101 from the S103.

On the other hand, if it is judged in the S102 that the display button 403 has been clicked, the management analysis server 14 advances the processing to the S104. In the S104, the management analysis server 14 executes display processing. In the display processing, all the data sets (or partial data sets comprising values of one or more evaluation factors that are set as the extracting conditions on the evaluation factor axes) that satisfy the combination of respective extracting conditions are extracted from the management analysis database 17 in accordance with respective extracting conditions that are currently set, and then, a portfolio map is displayed in the map area 41 of the main window in accordance with the data sets that have been extracted.

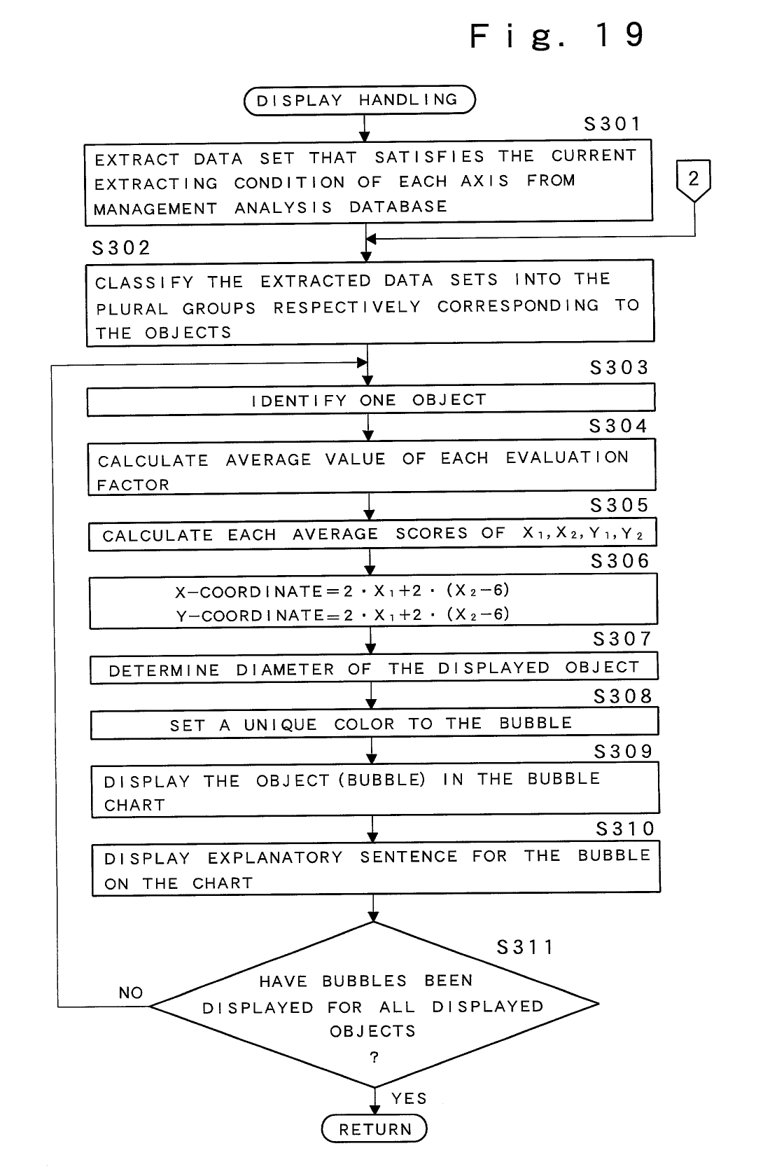

FIG. 19 is a flow chart illustrating the display processing subroutine to be executed in the S104. In the first step S301 of the subroutine, the management analysis server 14 extracts from the management analysis database 17 all the data sets (or partial data sets comprising values of one or more evaluation factors that are set as the extracting conditions on the evaluation factor axes) that simultaneously satisfy the respective extracting conditions which are currently set on the organization axis the year axis, the plan-result axis, the evaluator axis and the evaluation factor axis, which corresponds to extracting processor. However, if a plurality of element names is set as the extracting conditions on the same axis, these extracting conditions make the logical sum of the extracting conditions, and therefore a plurality of data sets are extracted. In addition, as described above, when an element name in an upper layer is set as the extracting condition on an axis but no corresponding data set is available, the management analysis server 14 extracts all data sets that are respectively present at the positions of all the element names which are subjacent to the element name in the upper layer.

In the next S302, the management analysis server 14 classifies the data sets, which have been extracted in the S301, into plural groups respectively corresponding to the objects to be displayed. More specifically, when no data set is present at the position of an element name in an upper layer that is set as the extracting condition in the S301 but the management analysis server 14 extracts data sets that are respectively present at the positions of all the element names which are subjacent to the element mane in the upper layer, the management analysis server 14 classifies the plurality of data sets into the same group, as those for displaying the same object. Incidentally, the data sets distributed along the year axis are classified by the day, by the week, by the month, by the quarter, by the half term, or by the year in accordance with the unit of the elements specified on the period axis.

Next, the management analysis server 14 executes the loop processing from the S303 to the S311 in order to display the objects on the portfolio map. In the first step S303 of the loop processing, the management analysis server 14 identifies one object to be displayed. More specifically, the management analysis server 14 identifies one group of data sets (some groups can comprise only one data set) that have been classified in the S302.

In the next S304, the management analysis server 14 calculates average values for respective evaluation factors among the group of data sets corresponding to the object to be displayed which had been identified in the S303, a general data set for the identified object. As a matter of course, when only one data set is available which is related to the identified object, the management analysis server 14 does nothing in the S304.

In the next S305, the management analysis server 14 classifies the respective evaluation factors of the data set, which have been obtained through the processing of the S304, by the upper layer item on the evaluation factor axis. More specifically, when respective evaluation factors on the PPM evaluation factor axis are set as the extracting conditions, the management analysis server 14 classifies the evaluation factors into four groups respectively related to the market strength, to the industrial competitive advantage, to the financial strength, and to the environmental stability. On the other hand, when respective evaluation factors on the BSC evaluation factor axis are set as the extracting conditions, the management analysis server 14 classifies the evaluation factors into four groups respectively related to the process viewpoint, to the organization and personnel viewpoint, to the stockholder viewpoint, and to the customer viewpoint. Furthermore, the management analysis server 14 calculates average scores for respective groups of evaluation factors to set a pair of average scores related to the X axis to X₁ and X₂, and to set a pair of average scores related to the Y axis Y₁ and Y₂. More specifically, when the respective evaluation factors on the PPM evaluation factor axis are set as the extracting conditions, the management analysis server 14 sets the average score of the evaluation factors related to the market strength to X₁, the average score of the evaluation factors related to the competitive advantage to X₂, the average score of the evaluation factors related to the financial strength to Y₁, and the average score of the evaluation factors related to the environmental stability to Y₂. On the other hand, when the respective evaluation factors on the BSC evaluation factor axis are set as the extracting conditions, the management analysis server 14 sets the average score of the evaluation factors related to the process viewpoint to X₁, the average score of the evaluation factors related to the organization and personnel viewpoint to X₂, the average score of the evaluation factors related to the stockholder viewpoint to Y₁, and the average score of the evaluation factors related to the customer viewpoint to Y₂.

In the next S306, the management analysis server 14 performs the aforementioned operations (1) and (2) on the respective average scores X₁, X₂, Y₁, and Y₂, which have been calculated in the S305 in order to calculate the X coordinate and Y coordinate. That is, the above processing from the S302 to S306 corresponds to coordinate calculating means.

In the next S307, the management analysis server 14 calculates an average value for the factor which is currently set as that the diameter of the bubble indicates, among the group of data sets corresponding to the identified object, in order to determine the diameter of the bubble of the identified object.

In the next S308, the management analysis server 14 sets a unique color to the bubble of the identified object.

In the next S309, the management analysis server 14 displays the identified object with the diameter determined in the S307 and the color set in the S308 at the position specified by the coordinates (X-coordinate and Y-coordinate) calculated in the S306 on the portfolio map in the map area 41 of the main window, which corresponds to window display means. Referring to the example of FIG. 24, the number of the data sets that satisfy the combination of the extracting conditions that the element name on the organization axis is “automobile division”, that the element name on the period axis is year, that the element name on the year axis is year 1999, and that the element name on the plan-result axis is plan present in the management analysis database 17 are the maximum of a α×β×365 pieces, where α is the total sum of the number of element names of the “automobile division” and elements subjacent thereto on the organization axis, and where β is the total sum of the element names (names of evaluators) in the lowermost layer on the evaluator axis. These data sets are all extracted; average values for respective evaluation factors are calculated among the extracted data sets; the respective average values are displayed in the list area 42; and then the object (bubble) that indicates the business position of the analyzed business unit with respect to the combination of the aforementioned retrieval conditions is displayed at a position of the portfolio map, the position being designated by the coordinates (X-coordinate and Y-coordinate) which are calculated in accordance with the average values of the respective evaluation factors.

In the next S310, the management analysis server 14 writes the element name corresponding to the displayed object on the predetermined axis (where data sets related to respective displayed objects are distributed) as an explanatory sentence for the displayed object (bubble), and draws a leader line between the explanatory sentence and the displayed object, on the portfolio map.

In the next S311, the management analysis server 14 checks whether or not the processing from the S303 to the S310 has been performed on all the objects to be displayed (in other words, the groups of data sets classified in the S302). If the processing has not yet been performed on all the objects to be displayed, the management analysis server 14 returns the processing to the S303 and then identifies the next object to be displayed.

On the other hand, if the processing has been performed on all the objects to be displayed as a result of repetition of the loop processing from the S303 to the S311, the management analysis server 14 gets out of the loop processing through the S311 ends the display operation subroutine, and then returns the processing to the routine of FIG. 17.

In the routine of FIG. 17 to which the processing has returned, the management analysis server 14 returns the processing from the S104 to the S101.

On the other hand, if it is judged in S102 that the specification button 404 has been clicked, the management analysis server 14 advances the processing to S105. In the S105, the management analysis server 14 executes bubble specification display processing. The bubble specification display processing is to display the contents of the individual objects (bubbles) displayed on the portfolio map, that is, the respective average scores X₁, X₂, Y₁, Y₂, which have been calculated in the S305, or the contents of the respective average values, that is, the evaluation values of the respective evaluation factors based on which the respective average values have been calculated.

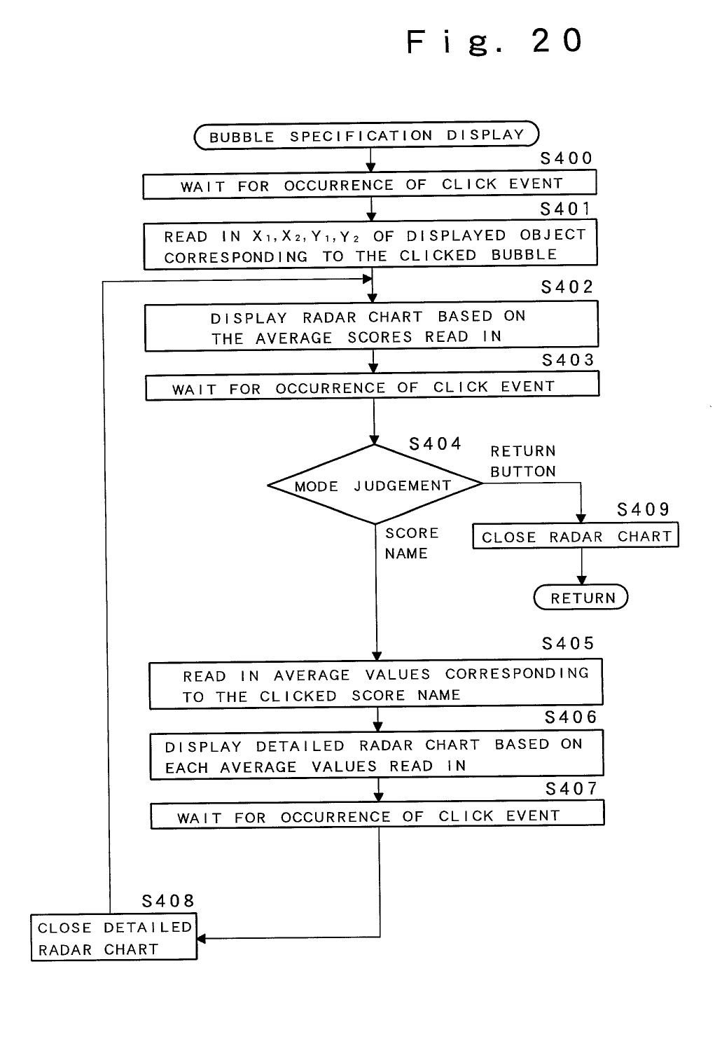

FIG. 20 is a flow chart showing the bubble specification display processing subroutine to be executed in the S105. In the first step S400 in the subroutine, the management analysis server 14 waits until one of the objects (bubbles) is clicked on the portfolio map. When one of the objects (bubbles) is clicked, in next S401, the management analysis server 14 reads in the respective average scores X₁ (the average value of the evaluation values related to the market strength or the average value of the evaluation values related to the process viewpoint), X₂ (the average value of the evaluation values related to the competitive advantage or the average value of the evaluation values related to the organization and personnel viewpoint), Y₁ (the average value of the evaluation values related to the financial strength or the average value of the evaluation values related to the stockholder viewpoint) and Y₂ (the average value of the evaluation values related to the environmental stability or the average value of the evaluation values related to the customer viewpoint), which have been calculated in the S305 in relation to the clicked object (bubble).

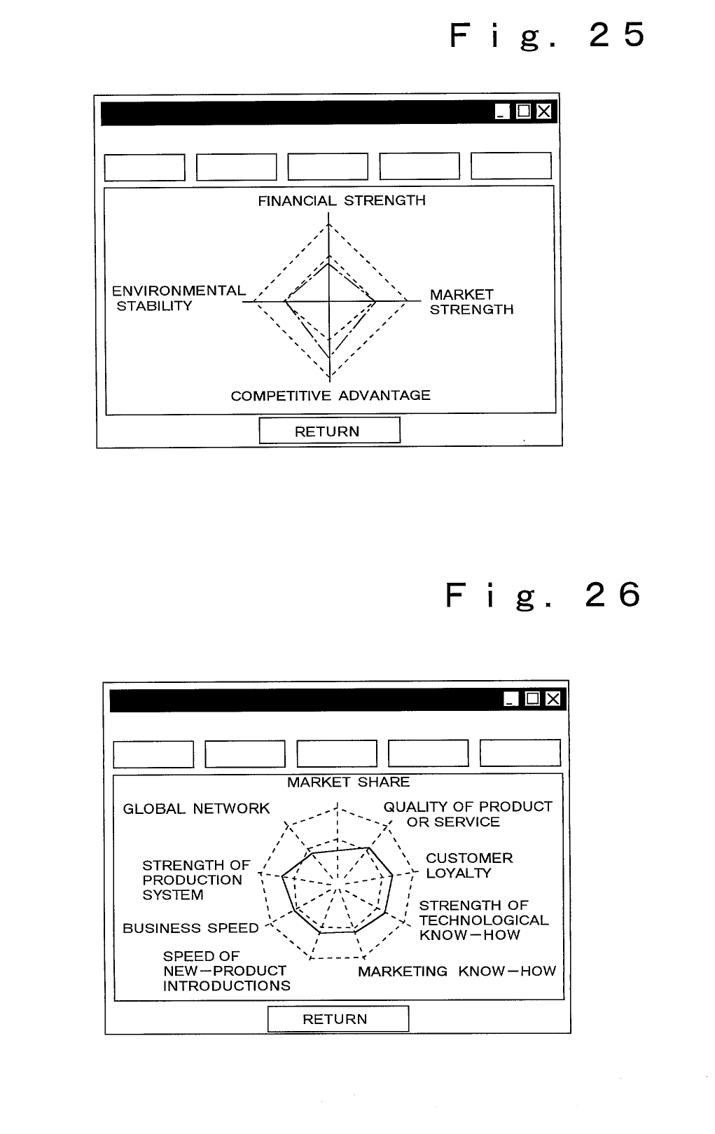

In the next S402, the management analysis server 14 displays a window for displaying a radar chart shown in FIG. 25, with it superimposed on the main window, in accordance with the respective average scores that have been read in in the S401. The radar chart corresponds to the conventional portfolio map, which has four axes corresponding to respective elements in the upper layer superior to the lowermost layer on the respective evaluation factor axes, with them contacting to each other at their origins and arranged in sequence at 90 degree intervals around the origin. Here, the four axes include the axes related to the market strength, the financial strength, the competitive advantage, and the environmental stability on the PPM evaluation factor axes. Whereas, the four axes include the axes related to the process viewpoint, the organization and personnel viewpoint, the stockholder viewpoint, and the customer viewpoint on the BSC evaluation factor axes. On the radar chart, the points corresponding to the respective average scores on each of the four axes are connected to each other to draw a quadrangle as a whole. Incidentally, the window for displaying the radar chart includes a return button.

In the next S403, the management analysis server 14 waits until either the name (the score name) of any one of the axes on the radar chart or the return button is clicked. When one of the score names or the return button is clicked, the management analysis server 14 determines in the S404 whether a score name or the return button has been clicked. If a score name has been clicked, in the S405, the management analysis server 14 reads in the evaluation values (the average values calculated in the S304) based on which the average score designated by the clicked score name is calculated in the S305.

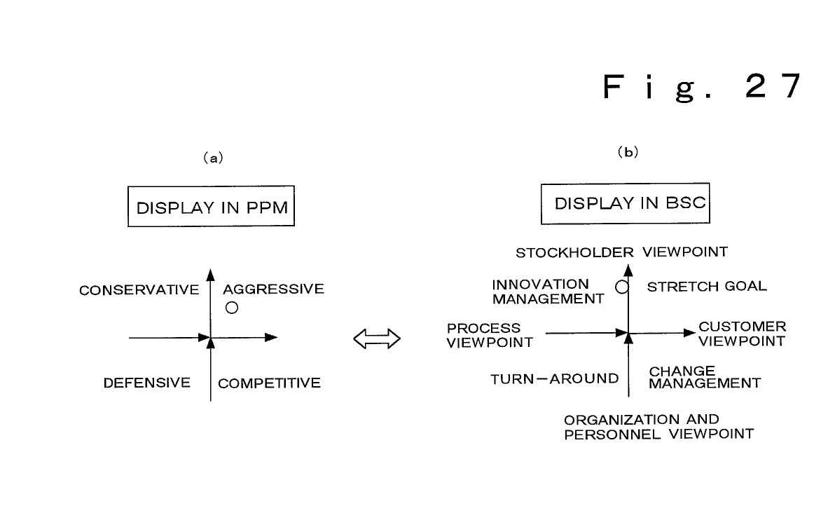

In the next S406, the management analysis server 14 displays a window for displaying a detailed radar chart shown in FIG. 26, with it superimposed on the main window, in accordance with the evaluation values (the average values) that has been read in in the S405. The detailed radar chart has the axes corresponding to the respective evaluation factors, with them contacting to each other at their origins and arranged at equal angle intervals. On the radar chart, the points corresponding to the respective evaluation values (average values) on the respective axes are connected to each other to draw a polygon as a whole. Incidentally, the window for displaying the detailed radar chart includes a return button.

In the next S407, the management analysis server 14 waits until the return button is clicked which is included in the window for displaying the detailed radar chart. When the return button is clicked, in the S408, the management analysis server 14 closes the window together with the detailed radar chart displayed in the S406 and thereafter returns the processing to the S402.

If it is determined in the S404 that the return button included in the window for displaying the radar chart has been clicked, in the S409, the management analysis server 14 closes the window together with the radar chart and then ends the bubble specification display processing subroutine to return the processing to the routine of FIG. 17.

In the routine of FIG. 17 where the processing has returned, the management analysis server 14 returns the processing from the S105 to the S101.

On the other hand, if it is judged in the S102 that the PPM/BSC switching button 407 has been clicked, the management analysis server 14 advances the processing to the S107. In the S107, the management analysis server 14 executes PPM/BSC switching processing. The PPM/BSC switching processing is to switch respective header items displayed in the list of the list area 42 from those of the PPM evaluation factor axis to those of the BSC evaluation factor axis or from those of the BSC evaluation factor axis to those of the PPM evaluation factor axis.

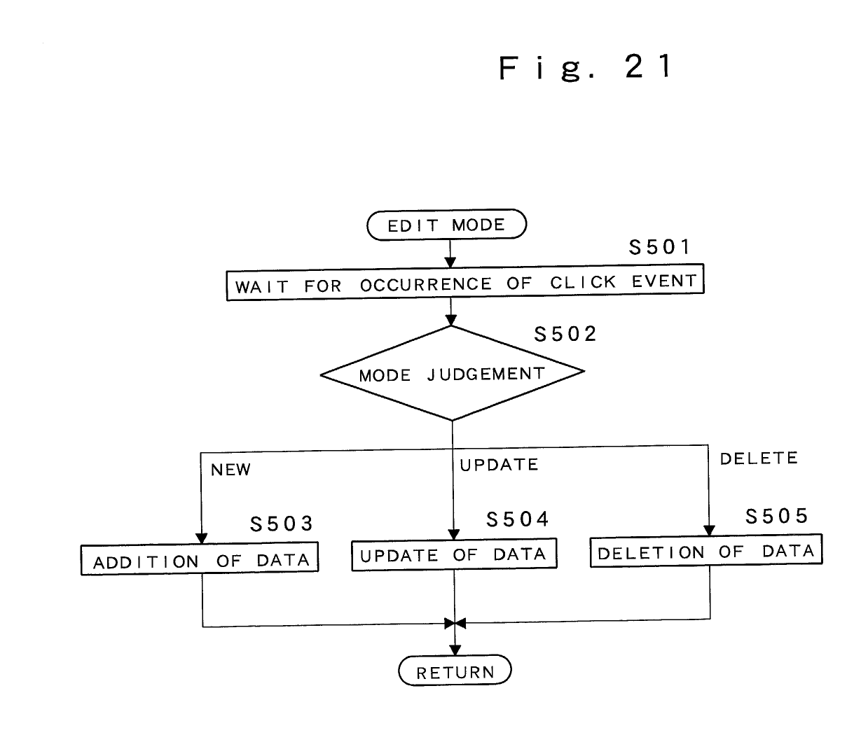

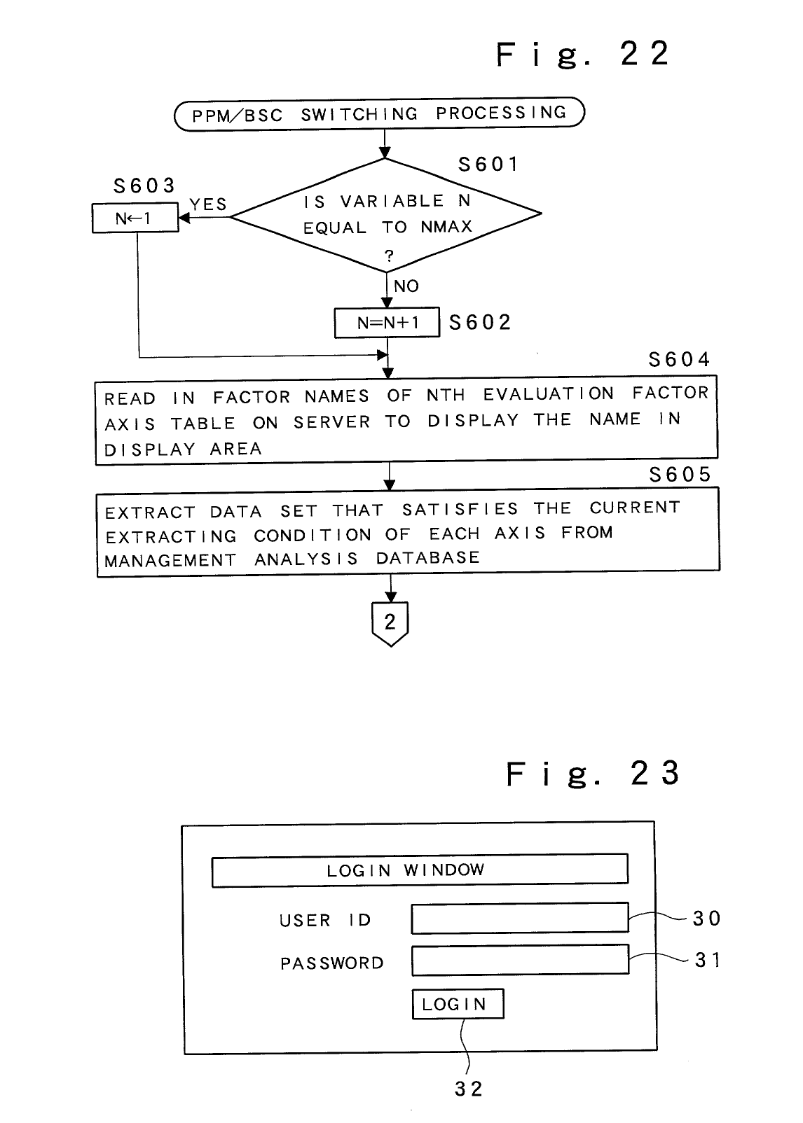

FIG. 22 is a flow chart illustrating the PPM/BSC switching processing subroutine to be executed in the S107. In the first step S601 of this subroutine, the management analysis server 14 checks whether the current variable N indicating the evaluation factor axes is consistent with Nmax. If the variable N is less than Nmax, the variable N is incremented by one in the S602. On the other hand, if the variable N is consistent with Nmax, the variable N is re-set to “1” in the S603 and thereafter the management analysis server 14 advances the processing to S604.

In the S604, the management analysis server 14 reads a series of evaluation factor names from the Nth evaluation factor axis table 18 to display the names in the list of the list area 42 as the aforementioned header items.

In the next S605, the management analysis server 14 sets all of the evaluation factors on the evaluation factor axes, displayed in the list of the list area 42 as header items, to extracting conditions. Thereafter, likewise in the S301, the management analysis server 14 extracts from the management analysis database 17 all the data sets that satisfy simultaneously the respective extracting conditions that are currently set on the organization axis, the year axis, the plan-result axis, the evaluator axis and the evaluation factor axis, which corresponds to extracting means. After having completed the S605, the management analysis server 14 advances the processing to the S302 to execute the processing subsequent to the S302.

On the other hand, if it is judged in the S102 that a button other than the chart button 402, the display button 403, the unit detail button 404, the PPM/BSC switching button 407 and the mode select button 401 has been clicked, the management analysis server 14 advances the processing to the S106. In the S106, the management analysis server 14 executes processing in accordance with the clicked button and thereafter returns the processing to the S101.

On the other hand, if it is judged in the S102 that the mode select button 401 has been clicked, the management analysis server 14 completes the browser mode.

FIG. 21 is a flow chart illustrating edit mode processing subroutine to be executed in the S018 of the main routine of FIG. 15. The edit mode processing is to store a new data set in the management analysis database 17 or erases or updates existing data sets. In the first step S501 of this subroutine, the management analysis server 14 indicates characters “Edit” in the mode indicating column 406 and at the same time displays a drop-down menu listing the options “New”, “Update” and “Delete”, and thereafter waits for one of the options of the menu to be clicked. When one of the options is clicked, the management analysis server 14 determines in S502 which option has been clicked.

If it is judged in the S502 that “New” has been clicked, the management analysis server 14 executes addition processing in S503. In the addition processing, the management analysis server 14 displays an input window, with it superimposed on the main window. The input window comprises a page including an organization column to be written with a business unit name, an evaluator name column to be written with an evaluator name and a plan-result column to be written with a plan or result, four pages respectively including evaluation score column to be written with respective evaluation factors corresponding to the current variable N, and a main page including a button linked with the respective pages and an OK button. When the current variable N corresponds to the PPM evaluation factor axis, the four pages respectively including the evaluation score column are a page including an evaluation score column for respective evaluation factors related to the environmental stability, a page including an evaluation score column for respective evaluation factors related to the market strength, a page including an evaluation score column for respective evaluation factors related to the competitive advantage, and a page including an evaluation score column for respective evaluation factors related to the financial strength. On the other hand, when the current variable N respectively corresponds to the BSC evaluation factor axis, the four pages respectively including the aforementioned evaluation score column are a page including an evaluation score column for respective evaluation factors related to the process viewpoint, a page including an evaluation score column for respective evaluation factors related to the organization and personnel viewpoint, a page including an evaluation score column for respective evaluation factors related to the stockholder viewpoint, and a page including an evaluation score column for respective evaluation factors related to the customer viewpoint. When the operator of the client computer 2 writes necessary items in the respective columns of the respective pages of the input window and then clicks the OK button, the management analysis server 14 prepares data sets in accordance with the contents written in the respective evaluation score columns. Then, the management analysis server 14 stores the data sets in the management analysis database 17 in order to be arranged in a logical space that is consistent with the respective positions of the present day on the year axis, the evaluator name written in the evaluator name column on the evaluator axis, the element name written in the plan-result column on the plan-result axis, and the respective evaluation factors on the evaluation factor axis. After having completed the S503 as described above, the management analysis server 14 completes the edit mode processing subroutine.

On the other hand, if it is judged in the S502 that “Update” has been clicked, the management analysis server 14 executes update processing in S504. In the update processing, the management analysis server 14 waits until one of the objects (bubbles) displayed on the portfolio map is clicked. When one of the objects (bubbles) is clicked, the management analysis server 14 displays a list of the group of data sets related to the object. Then, if one of the data sets is selected from the list, the selected data set is read from the management analysis database 17. Then, the management analysis server 14 displays the input window, having the same configuration as the one displayed in the aforementioned S503, with it superimposed on the main window and indicates the values of the data sets read from the management analysis database 17 in the respective columns of the respective pages of the input window displayed. Thereafter, if the operator of the client computer 2 clicks the OK button after having rewritten the contents of the respective columns of the respective pages in the input window, the management analysis server 14 updates the data set in the management analysis database 17 in accordance with the current contents of the respective columns of the respective pages in the input window. After having completed the S504 as described above, the management analysis server 14 completes the edit mode processing subroutine.

On the other hand, if it is judged in the S502 that “Delete” has been clicked, the management analysis server 14 executes data delete processing in S505. In the delete processing, the management analysis server 14 waits until one of the objects (bubbles) displayed on the portfolio map is clicked. When one of the objects (bubbles) is clicked, the management analysis server 14 displays a list of the group of data sets related to the object. Then, if one of the data sets is selected from the list, the selected data set is deleted from the management analysis database 17. After having completed the S505 as described above, the management analysis server 14 completes the edit mode processing subroutine.

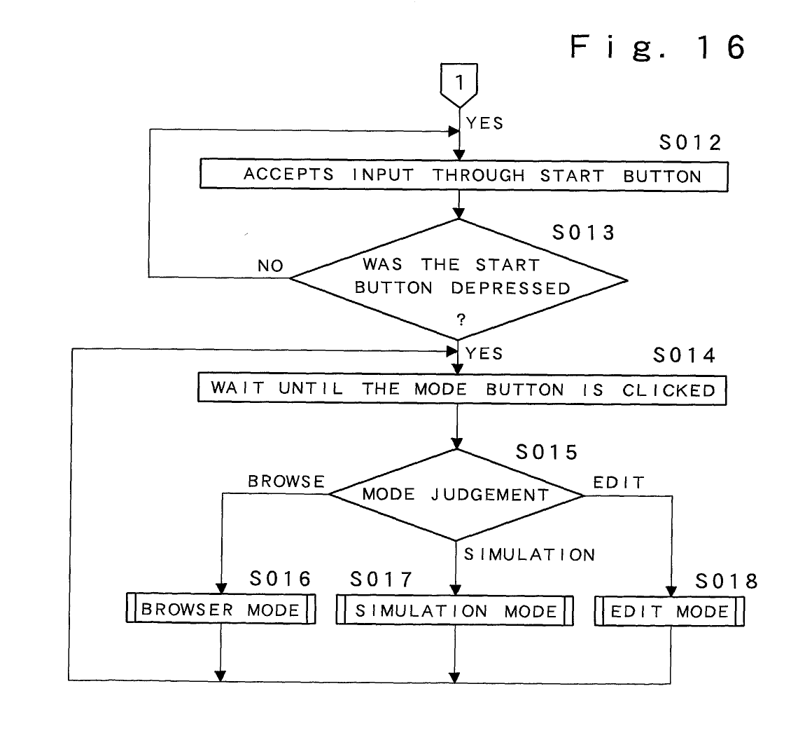

Incidentally, in the aforementioned simulation mode processing to be executed in the S017 of FIG. 16, processing equivalent to the edit mode processing shown in FIG. 21 and processing equivalent to the browser mode processing shown in FIG. 17 are selected by the operator and then executed. In the processing equivalent to the edit mode processing executed in the S017, the result of the data addition processing (see S503), the data update processing (see S504), and the data delete processing (see S505) is not reflected upon the original of the management analysis database 17 stored in the hard disk 13 but reflected only upon data copied on the RAM 24 of the client computer 2. Moreover, in the processing equivalent to the browser mode processing executed in the S017, the display processing (see S104) is carried out in accordance with copied data of the management analysis database 17 present on the RAM 24 of the client computer 2. Therefore, a change in object (bubble) can be simulated on a portfolio map by arbitrarily changing, adding, or deleting the contents of the respective data sets stored in the management analysis database 17 without modifying at all the original of the management analysis database 17 itself stored in the hard disk 13 of the host computer 1. When the mode select button 401 is clicked while the simulation mode processing is being executed, the management analysis server 14 completes the simulation mode processing.

Advantages provided by the embodiment

Then, in the business position display system according to the embodiment configured as described above, the position of an analyzed business unit in business environments is displayed as an absolute position on a portfolio map by an object in the shape of a bubble (circle) with no meaning of directions. Accordingly, it is made possible to display positions of a plurality of analyzed business units at the same time on the same portfolio map, which provides a common evaluation reference. Moreover, the data sets based on which the objects are displayed are those extracted from a multi-dimensional database in which evaluation values (data sets) about a plurality of business units obtained through analysis from various viewpoints are stored at positions defined on various references (axes) in accordance with the desired extracting conditions on respective axes, and thereafter summarized based on the desired tallying conditions. Therefore, various groups of objects with various meanings can be displayed by arbitrarily setting respective extracting conditions and tallying conditions. For example, it is possible to simultaneously display positions of an analyzed business unit which changes over time. Furthermore, it is also possible to display the result and plan of an analyzed business unit at the same time. Still furthermore, it is also possible to display positions of own company and other companies at the same time, to display a distribution of positions of own company's respective business groups, to display a distribution of positions of respective divisions belonging to a certain business group, and to display a distribution of positions of products dealt by a certain division. In this case, layers of an analyzed business unit to be displayed can be arbitrarily interchanged with one another. Furthermore, it is also possible to display respective positions of an analyzed business unit evaluated by individual evaluators and one position of an analyzed business unit evaluated by a whole group of a plurality of evaluators. In this case, layers of evaluators for the analyzed business unit can be arbitrarily interchanged with one another. Furthermore, it is also possible to arbitrarily edit (add, update, or delete) evaluation values based on which objects are displayed. In addition, every time the PPM/BSC switching button 407 is clicked, evaluation factor axes are switched over, and extracted data sets are switched alternately from those on the PPM evaluation factor axis to those on the BSC evaluation factor axis or from those on the BSC evaluation factor axis to those on the PPM evaluation factor axis. Consequently, this makes it possible to alternately switch the management analysis approach appearing on the portfolio map between an approach equivalent to the SPACE and one equivalent to the BSC.

According to this embodiment, positions of an analyzed business unit can be displayed from various angles as described above, thereby providing the following advantages. For example, every time a change of market environment continuing to vary or respective business unit therein is sensed, it is possible to check the positioning of the business units on a matrix quickly.

Furthermore, in the study of the position of business or the portfolio of investment, respective business units which are company, business groups, divisions and products constituting a layered structure are investigated. In this case, it is possible to evaluate the respective layer with the same standard, thus facilitating recognition of the present condition in an arbitrary layer.

Furthermore, since changes in position and the target position of a business unit can be made clear, the gaps between them can be analyzed.

Furthermore, since positions of competitors can be studied at the same time, the business position display system provides a function of industry maps.

In addition, the position of an analyzed business unit on a portfolio map (that is, the coordinates of an object in the rectangular coordinate system) is calculated in accordance with evaluation values for a plurality of evaluation factors. The respective evaluation values are displayed in a radar chart and a detail radar chart, thereby facilitating checking the cause of taking the position.

In addition, it is also possible to perform a simple impact analysis (that is, simulation) to know degree of a change in position of an analyzed business unit on the portfolio map by changing an evaluation value for an arbitrary evaluation factor.

Furthermore, it is also possible for a plurality of evaluators to carry out evaluation and discussion together at the same time to decide evaluation scores even when they are remotely separated from one another. This makes it possible to improve the speed of organizational training and decision making.

Furthermore, by comparing the present condition with the past results and by changing the environmental prediction, the feasibility of plans can be checked. Furthermore, it is also possible to recognize an evaluation factor with a significant change in rating as a critical problem.

Recently, every company has started to control financial indices such as the Balanced Scorecard and the management items of the Business Process Management and non-financial indices. Such management items are taken into the evaluation factors of the business portfolio in the business position display system and evaluation data as to the items are made automatically reflected on the evaluation factors of the business portfolio in the business position display system from the database where the evaluation data are reviewed weekly or monthly. Alternatively, the evaluation values of the evaluation factors of the industry are stored in a database and the values read from the database are made reflected on the evaluation factors of the industry in the business portfolio on the business position display system. These make it possible to automatically update and review the portfolio in a short period of time.

Modified Example

In the aforementioned embodiment, every time respective data sets are extracted from the management analysis database 17, average scores X₁, X₂, Y₁, and Y₂ related to the respective business units are calculated in accordance with respective evaluation values that constitute the extracted data sets. However, after having been calculated once, the respective average scores X₁, X₂, Y₁, and Y₂ may be incorporated into a data set stored in the management analysis database 17. In this case, the respective average scores X₁, X₂, Y₁, and Y₂ that have been incorporated into the data set will remain valid until any one of evaluation values that constitute the data set is updated thereafter. Accordingly, the management analysis server 14 can read the respective average scores X₁, X₂, Y₁, and Y₂, instead of the data set from the management analysis database 17, thereby eliminating the calculation of the respective average scores X₁, X₂, Y₁, and Y₂ in accordance with respective evaluation values.

Effect of the Invention

According to the business position display system of the present invention configured as described above, the position of an analyzed item in business environments can be indicated in a multi-dimensional space displayed with other items.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A business position display system for illustrating a position in business environment of a business unit to be analyzed, comprising:
a storage device for storing evaluation values respectively set to a plurality of evaluation factors, for every business unit to be analyzed;
an extracting processor extracting evaluation values related to said business unit to be analyzed out of said storage device in accordance with a predetermined extracting condition;
a coordinate calculating processor calculating coordinates in a multi-dimensional space in accordance with respective evaluation values extracted by the extracting processor; and
a display processor showing an object at a position corresponding to the coordinates calculated by said coordinate calculating processor in said multi-dimensional space on a screen.

2. The business position display system according to claim 1, wherein
said storage device stores the evaluation values in a multi-dimensional database in which a multi-dimensional space is logically defined with a plurality of axes respectively representing reference, said evaluation value being positioned in accordance with logical position of its attribute on each axis, and
said extracting processor extracts an evaluation value of which logical position of its attribute on each axis corresponds to the extracting condition.

3. The business position display system according to claim 2, further comprising condition setting device for arbitrarily setting said extracting condition.

4. The business position display system according to claim 2, wherein
at least one of the axes logically defining a multi-dimensional space in said multi-dimensional database includes a plurality of elements concerning references which have relationship of a layered structure with each other.

5. The business position display system according to claim 2, wherein
said coordinate calculating processor calculates, when said extracting processor extracts evaluation values related to a plurality of business units, a plurality of the coordinates for respective business units in accordance with said evaluation values, and
said display processor shows, when a plurality of coordinates are calculated by said coordinate calculating processor, a plurality of objects at positions respectively corresponding to the coordinates.

6. The business position display system according to claim 2, wherein
when a predetermined tallying condition is satisfied between a plurality of evaluation values extracted by said extracting processor, said coordinate calculating processor tallies up the evaluation values satisfying said tallying condition to calculate a new evaluation value and thereafter calculates coordinate in accordance with the new evaluation value.

7. The business position display system according to claim 1, wherein
the multi-dimensional space in which said object is shown by said display processor is a two-dimensional space defined by rectangular coordinate system.

8. The business position display system according to claim 7, wherein
said respective evaluation factors are roughly classified into those related to environmental stability of industry, market strength, competitive advantage of a business unit to be analyzed, and financial strength of the business unit to be analyzed, and
said coordinate calculating processor calculates coordinate on a first axis constituting said rectangular coordinate system in accordance with evaluation values of evaluation factors related to said market strength and said competitive advantage of the business unit to be analyzed, and coordinate on a second axis constituting said rectangular coordinate system in accordance with evaluation values of evaluation factors related to said environmental stability of the industry and said financial strength of the business unit to be analyzed.

9. The business position display system according to claim 7, wherein
said respective evaluation values are roughly classified into those related to a process viewpoint, an organization and personnel viewpoint, a stockholder viewpoint, and a customer viewpoint, and
said coordinate calculating processor calculates coordinate on a first axis constituting said rectangular coordinate system in accordance with evaluation values of evaluation factors related to said process viewpoint and said organization and personnel viewpoint, and coordinate on a second axis constituting said rectangular coordinate system in accordance with evaluation values of evaluation factors related to said stockholder viewpoint and said customer viewpoint.

10. The business position display system according to claim 2, wherein
in said multi-dimensional database, said respective evaluation values are classified, according to evaluation factor axis representing reference about types of respective evaluation factors, into a first group comprising those related to environmental stability of industry, market strength, competitive advantage of the business unit to be analyzed and financial strength of the business unit to be analyzed, and a second group comprising those related to the process viewpoint, the organization and personnel viewpoint, the stockholder viewpoint and the customer viewpoint, and
said extracting processor selectively extracts only evaluation values of evaluation factors belonging to either one of said first group or said second group in accordance with an extracting condition as to said evaluation factor axis.

11. A computer-readable medium for storing data of evaluation values respectively set to a plurality of evaluation factors for every business unit to be analyzed, and a program making computer:
extract an evaluation value related to the business unit to be analyzed in accordance with a predetermined extracting condition;
calculate coordinates in a multi-dimensional space in accordance with the extracted evaluation value; and
output a image data for showing an object at a position corresponding to said calculated coordinates in the multi-dimensional space on a screen.
